(19) United States
(12) Patent Application Publication
(10) Pub. No.: US 2006/0226572 A1
(43) Pub. Date: Oct. 12, 2006

(54) Electrophotographic endless belt, electrophotographic apparatus, and process for producing electrophotographic endless belt

(75) Inventors: Atsushi Tanaka, Sunono-shi (JP); Akihiko Nakazawa, Sunto-gun (JP); Takashi Kusaba, Sunto-gun (JP); Hidekazu Matsuda, Numazu-shi (JP); Kenichi Yamauchi, Sunono-shi (JP); Yuji Sakurai, Sunono-shi (JP); Norifumi Muranaka, Numazu-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/315,283

(22) Filed: Dec. 23, 2005

(30) Foreign Application Priority Data
Apr. 6, 2005 (JP) 2005-109883

(51) Int. Cl. B32B 27/34; B32B 27/20

(52) U.S. Cl. 264/176.1; 428/474.4; 428/421; 428/411.1

(57) ABSTRACT

An electrophotographic endless belt is disclosed having a layer formed of a resin composition containing (i) at least one resin selected from the group consisting of a polyether ester amide, a polyolefin ether and a polyether amide; (ii) polyvinylidene fluoride; and (iii) carbon. In the resin composition, the ratio of the mass of the component (iii) to the mass of the component (i) is in a specific range.

### BACKGROUND OF THE INVENTION

1. Field of the Invention

This invention relates to an electrophotographic endless belt such as a transfer material transport belt or an intermediate transfer belt, used in electrophotographic apparatus, an electrophotographic apparatus having the electrophotographic endless belt, and a process for producing the electrophotographic endless belt.

2. Related Background Art

Electrophotographic endless belts such as a transfer material transport belt and an intermediate transfer belt (hereinafter referred to also simply as “belt(s)”) are often used in color electrophotographic apparatus. Then, the color electrophotographic apparatus using these belts are roughly grouped into two types.

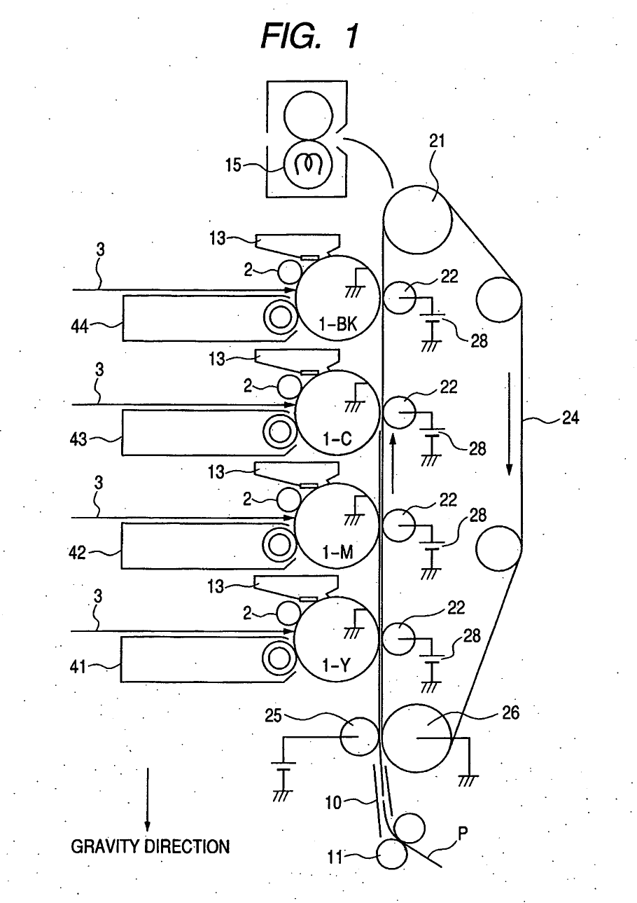

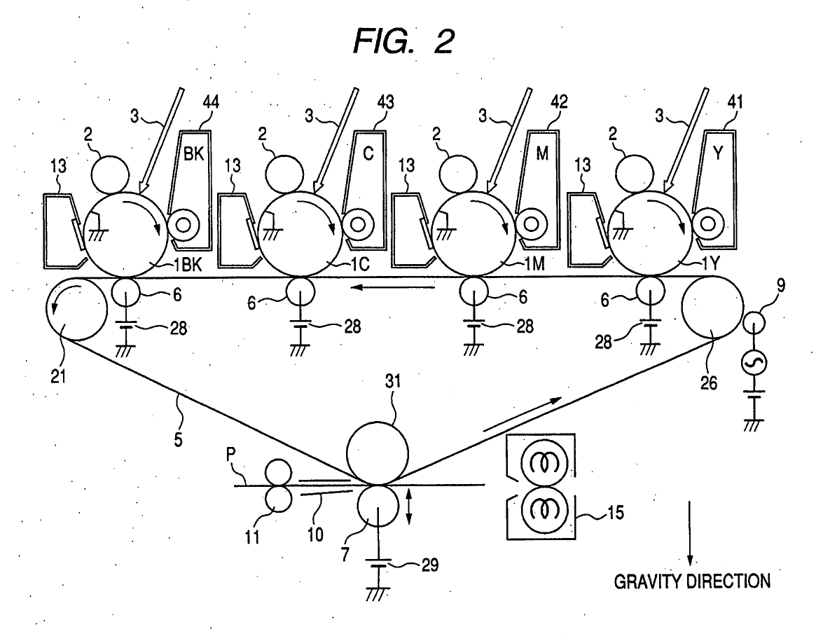

One of them is, as shown in FIG. 1 or 2, a color electrophotographic apparatus of the so-called tandem type, in which different-color toner images formed on a plurality of electrophotographic photosensitive members are sequentially transferred to a transfer material held on a transfer material transport belt or to an intermediate transfer belt.

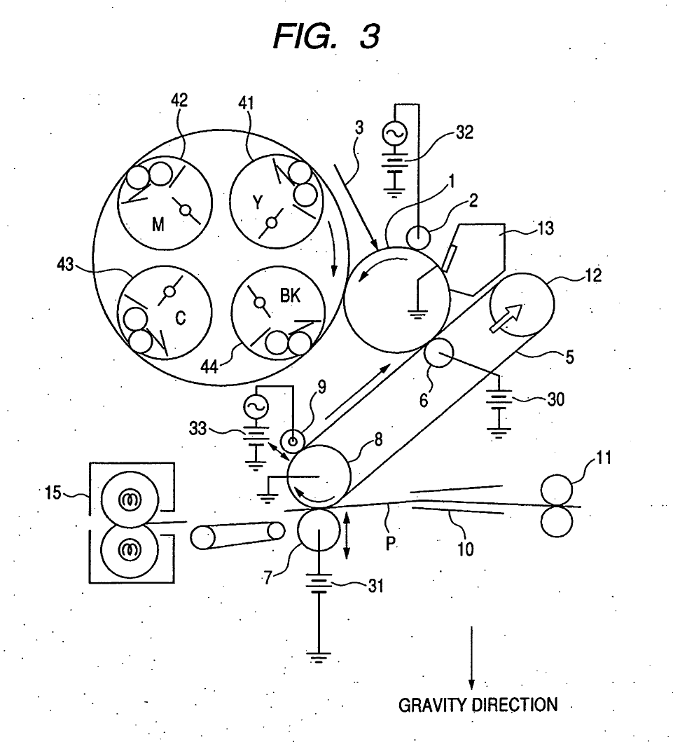

The other of them is, as shown in FIG. 3, of a type which uses a single electrophotographic photosensitive member and an intermediate transfer belt, and is a color electrophotographic apparatus of a system in which the intermediate transfer belt is rotated a plurality of times necessary for superimposing different-color toner images (four times in the case when four kinds of toners are used) and thereafter the respective color toner are together transferred to a transfer material P.

In color electrophotographic apparatus in recent years, printing speed has dramatically been improved, and apparatus employing the tandem type color electrophotographic apparatuses are increasing as being advantageous for achieving high speed. In particular, an electrophotographic apparatus has already been commercially available in which, as shown in FIG. 1, a transfer material transport belt is used, image forming units each having an electrophotographic photosensitive member are disposed in a vertical line or an oblique line, and a transfer material is transported from the lower part to the upper part (against the direction of gravity). The color electrophotographic apparatus of this type attracts attention because the space to install apparatus main-body therein can be small. In order to make the feature “space saving” more remarkable, it may be contemplated that an attracting roller 25 used in conventional electrophotographic photosensitive members is not provided to achieve further space saving and cost reduction. The attracting roller is a roller which is usually provided at a position where it faces a stretch-over roller 26 in such a form that a transfer material transport belt 24 is held between them, and is used in order to hold a transfer material tightly between this roller and the transfer material transport belt. In addition, a bias may also be applied to the attracting roller to provide paper with electric charges so that the paper can more surely be attracted to the transfer material transport belt.

In order to materialize the above, the force of attracting the transfer material transport belt is more required than conventional cases. In particular, in order to attract to the transfer material transport belt a transfer material containing moisture in a high-temperature and high-humidity environment, a very high attracting force is required. The improvement of the attracting force can be easily materialized by imparting a high resistivity to the transfer material transport belt. However, where the belt is made to have a high resistivity, there is a problem in that the stability of image density during repeated image reproduction is lost. The reason why the stability of image density is lost is considered as below.

In the color electrophotographic apparatus as shown in FIG. 1, before images are formed, toner images of from several millimeters to tens of millimeters square in size are transferred onto the belt under different density (toner quantity) for each color. The toner images having been transferred onto the belt are called patch images. Then, in order to detect the toner quantity of each patch image by an optical means, a sensor is provided in the vicinity of the belt surface. This sensor is so designed that the belt surface is irradiated with light (e.g., infrared radiation) and the light reflected from the belt surface can be detected. At areas having no patch image on the belt, the light reflects strongly because of the gloss of the belt surface. On the other hand, at areas having patch images on the belt, the light is reflected in a small amount in accordance with the density of patch images. Thus, changes in the amount of reflected light may be read, whereby the toner quantity on the belt can be known. The information obtained is fed back to development bias or latent-image potential to make corrections when image formation on transfer material is performed (hereinafter “patch detecting correction”), to stabilize the image density at the time of image reproduction on the transfer material. If the belt has a high resistivity when this patch detecting correction is performed, the electric charges having flowed into the belt are difficult to eliminate, resulting in a very high potential on the belt. In that case, an abnormal discharge takes place between the belt and the electrophotographic photosensitive member, so that the patch images which should have had a uniform density are disrupted to appear as a pattern like polka dots (hereinafter “polka dot pattern”). Once the polka dot pattern has appeared, the density of patch images changes, and hence the original proper toner quantity is no longer detectable. As a result, the image density is controlled at a level different from the original proper feedback level, resulting in a color tone aberrant from the desired one. If the position, shape and size at or in which the polka dot pattern appears are always identical, corrections can be made. Since, however, the polka dot pattern is caused by abnormal discharge, the position of appearance, shape and size thereof are not constant. As a result, the color tone may change every time the patch detecting correction is performed.

As stated above, if the attracting force is increased merely by increased the resistivity of the belt, the polka dot pattern appears in the patch images to cause such a problem that the stability of image density during repeated image reproduction is lost. Accordingly, it is very difficult to balance at a high level the attracting force (in particular, attracting force in a high-temperature and high-humidity environment) with the stability of image density during repeated image reproduction.

The belt is also required to have a good toner-removal cleanability, which is an important property especially in the case of belts used in electrophotographic apparatus which perform the patch detecting correction. This is because, after patch density on the belt has been read, the patch images, i.e., toner images are removed from the belt surface (the belt surface is cleaned) and thereafter the step of image formation on the transfer material is carried out, and hence the belt must have a good toner-removal cleanability.

As a material having a good toner-removal cleanability, fluorine resins are cited, and belts as shown below are proposed.

In Japanese Patent Application Laid-open No. H02-106530 (Patent Document 1), an endless belt is proposed in which polyether ester amide (PEEA and sodium dodecylbenzenesulfonate (DBDS) as conducting agents are added to a fluorine resin composed of vinylidene fluoride and hexafluoropropene. However, according to studies made by the present inventors, it has turned out that this belt little has almost no transfer material attracting force and may cause color aberration very seriously when set as a transfer material transport belt in the tandem type electrophotographic apparatus. It has also turned out that, when halftone images having a uniform density are reproduced, horizontal streak-like thick lines appear in the vicinity of the rear end of a transfer material (rear-end horizontal lines). This phenomenon of rear-end horizontal lines is considered to be caused by the slipping of the transfer material in the course of the step of transferring toner images from the electrophotographic photosensitive member to the transfer material, because of a further lowering of attracting force due to a decrease in the contact area between the transfer material transport belt and the transfer material at the rear end of the transfer material.

In Japanese Patent Application Laid-open No. 2000-143918 (Patent Document 2), a belt is proposed which comprises a fluorine resin and 1 to 40 parts by mass of grafted carbon and 1 to 15 parts by mass of a thermoplastic polyether resin.

In Japanese Patent Application Laid-open-No. H07-113029 (Patent Document 3), a resin composition is proposed which comprises a polyvinylidene fluoride resin and 1 to 20 parts by mass of a conductive filler and 2 to 10 parts by mass of a thermoplastic polyether resin.

However, Patent Document 2 (Japanese Patent Application Laid-open No. 2000-143918) and Patent Document 3 (Japanese Patent Application Laid-open No. H07-113029) do not disclose that the proportion of carbon to polyether resin is important in order to achieve both the attracting force and the stability of image density during repeated image reproduction. Then, the belts disclosed in Patent Document 2 (Japanese Patent Application Laid-open No. 2000-143918) and Patent Document 3 (Japanese Patent Application Laid-open No. H07-113029) contain more polyether resin than carbon, and hence have a poor attracting force. In addition, according to the fact that they have a low volume resistivity, they have further low attracting force. Actually, it has been attempted to set in the tandem type electrophotographic apparatus each of belts described in Examples given in Patent Document 2 (Japanese Patent Application Laid-open No. 2000-143918) and Patent Document 3 (Japanese Patent Application Laid-open No. H07-113029), where color aberration occurred very seriously and the rear-end horizontal lines also appeared.

Thus, it can be said that no belt has been available which can sufficiently attract the transfer material even without any attracting roller and also has the stability of image density during repeated image reproduction.

### SUMMARY OF THE INVENTION

An object of the present invention is to provide an electrophotographic endless belt having high attracting force and the stability of image density during repeated image reproduction when used as a transfer material transport belt.

Another object of the present invention is to provide an electrophotographic endless belt which has the stability of image density during repeated image reproduction and is not causative of re-transfer (a phenomenon such that toner transferred once onto an intermediate transfer belt returns to the electrophotographic photosensitive member) when used as an intermediate transfer belt.

Still another object of the present invention is to provide an electrophotographic apparatus having such an electrophotographic endless belt.

According to the present invention, an electrophotographic endless belt is provided which has a layer comprising a resin composition containing:

(i) at least one resin selected from the group consisting of a polyether ester amide, a polyolefin ether and a polyether amide;

(ii) polyvinylidene fluoride; and

(iii) carbon,

wherein the mass (A) of the component (iii) and the mass (B) of the component (i) is in a ratio (A/B) of from 4 or more to 50 or less.

According to the present invention, an electrophotographic apparatus is also provided having the above electrophotographic endless belt.

### BRIEF DESCRIPTION OF THE INVENTION

FIG. 1 is a view showing an electrophotographic apparatus having a transfer material transport belt, a plurality of electrophotographic photosensitive members and an attracting roller.

FIG. 2 is a view showing an electrophotographic apparatus having an intermediate transfer belt and a plurality of electrophotographic photosensitive members.

FIG. 3 is a view showing a four-pass type electrophotographic apparatus having an intermediate transfer belt.

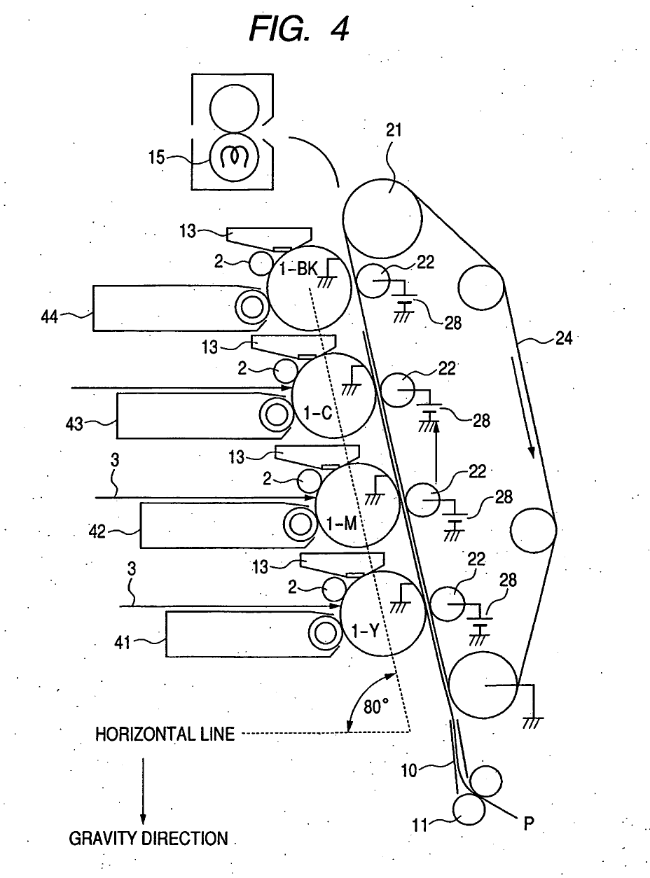

FIG. 4 is a view showing an electrophotographic apparatus having a transfer material transport belt and a plurality of electrophotographic photosensitive members and having no attracting roller.

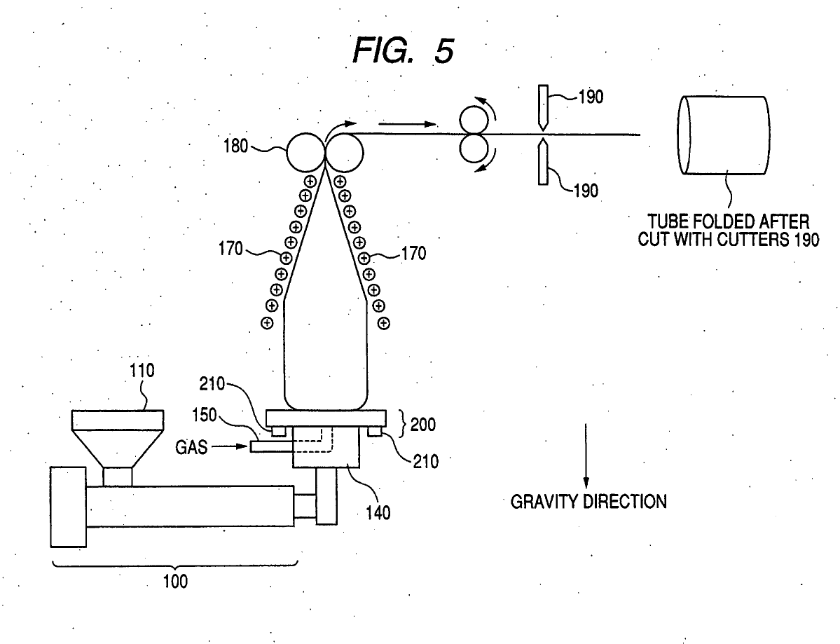

FIG. 5 is a schematic view of a blown-film extrusion (inflation) machine.

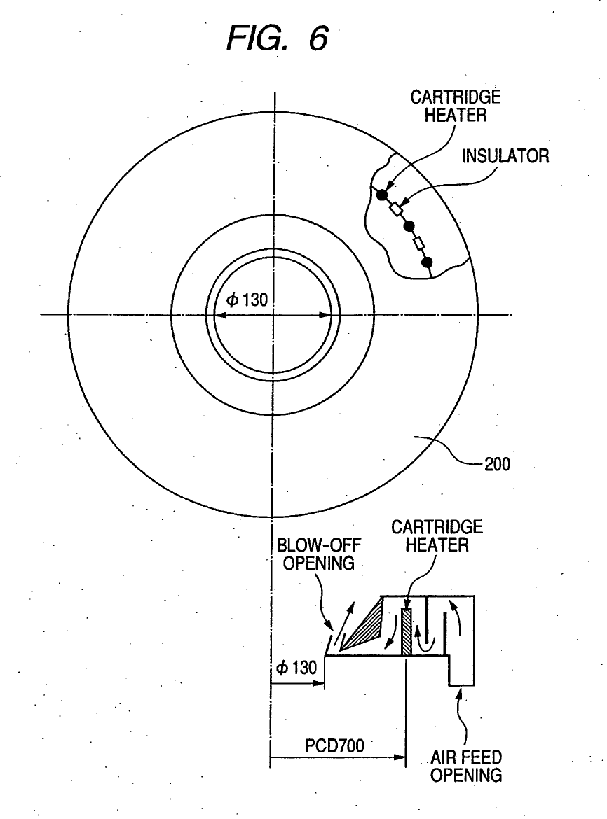

FIG. 6 is a schematic view of an air ring.

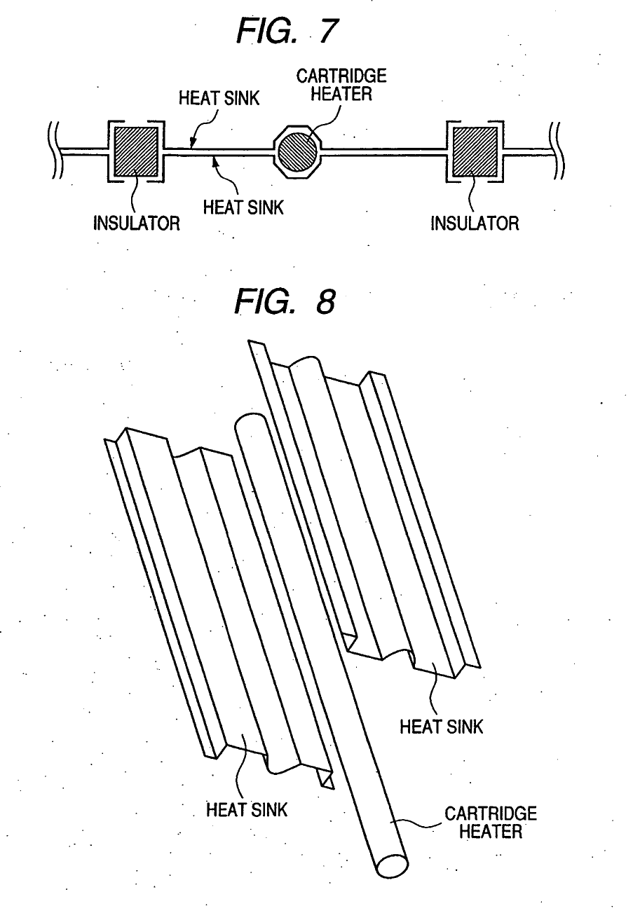

FIG. 7 is an enlarged view of a heater, heat sinks and insulators provided in the interior of the air ring.

FIG. 8 is a view showing how the heater is held between the heat sinks.

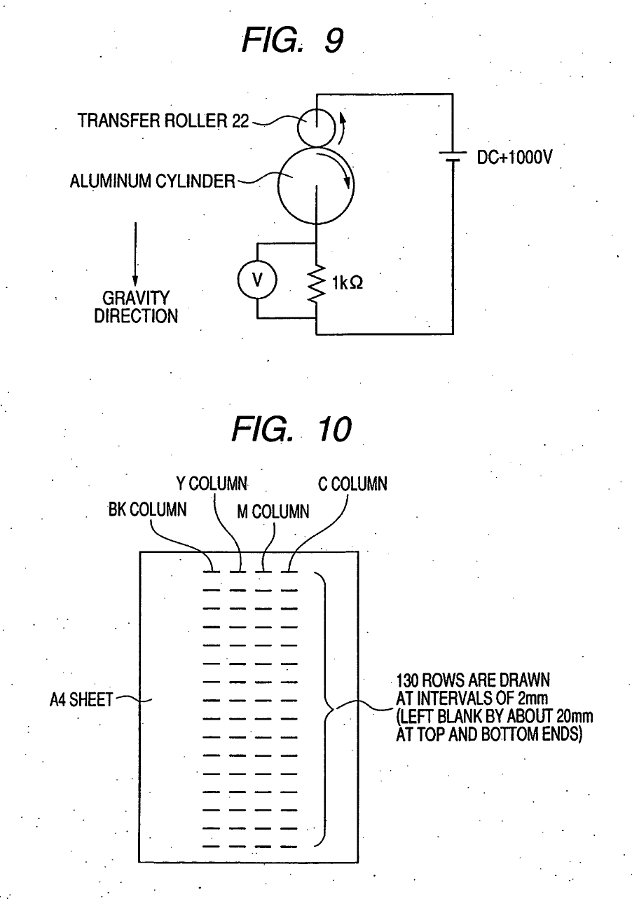

FIG. 9 is a view showing how to measure the resistivity of a transfer roller.

FIG. 10 is a view showing an image reproduction pattern for measuring color aberration.

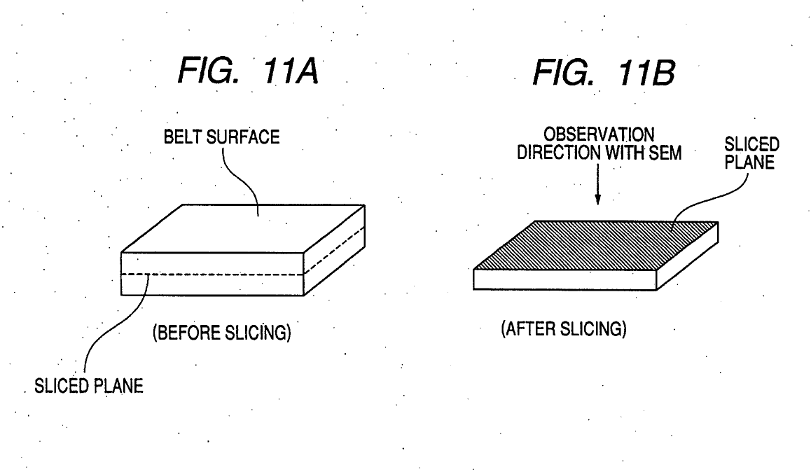

FIGS. 11A and 11B are views showing the direction of observation in determining the average particle diameter of graphite particles.

### DESCRIPTION OF THE PREFERRED EMBODIMENTS

How the present inventors have arrived at the present invention is described first.

As stated previously, the present inventors have taken notice of fluorine resins which are known to have a superior releasability and a good belt cleanability because of their low surface energy, in particular, polyvinylidene fluoride (PVDF), which can be handled with ease in manufacturing belts because of its low working temperature.

First, the present inventors kneaded and incorporated carbon in the polyvinylidene fluoride to produce belts having different resistivities. Next, they have set each of the produced belts in the electrophotographic apparatus shown in FIG. 4, to make evaluation in an environment of 23° C./55% RH. As a results where the carbon was added in a small quantity and belts had a high resistivity, high attracting force was achievable and neither color aberration nor rear-end horizontal lines appeared. However, such belts were lacking in the stability of image density during repeated image reproduction. In order to examine the cause of lacking in the stability of image density, they turned off the switch of the electrophotographic apparatus to stop its operation in the midst of reading the density of patch images with a sensor, and observed the patch images on the belt. As a result, the polka dot pattern was seen in the patch images. From this fact they considered that, in belts having a high resistivity, abnormal discharge took place between the electrophotographic photosensitive member and the belt, and disrupted the patch images so that the patch density is not accurately detectable.

Accordingly, they added the carbon in a large quantity for the belt to have a low resistivity. As a result, the polka dot pattern no longer appeared in the patch images and the stability of image density came to be maintainable. However, in a high-temperature and high-humidity environment (30° C./80% RH), the force of attracting paper to the belt lowered, so that the color aberration occurred seriously and the rear-end horizontal lines appeared.

Thus, the attracting force and the stability of image density showed a tendency to conflict with each other. Accordingly, in order to discover whether any concentration of carbon achieving both of these exists, the present inventors finely divided the amount of the carbon to be added, conducting researches. However, it was unable to achieve both the attracting force and the prevention of the polka dot pattern.

Next, the present inventors used, as the conducting agent (carbon), metallic powder, polyether ester, amide, potassium perfluorobutanesulfonate (a sulfonic acid metal salt), sodium dodecylbenzenesulfonate and so forth to conduct the same researches as in the case of the carbon. However, any conducting agents as well showed the same tendency as the carbon. More specifically, when added in a small quantity, the stability of image density was poor, and, when added in a large quantity, the attracting force was insufficient, so that the color aberration occurred seriously and the rear-end horizontal lines appeared. Then, it was unable to achieve both the stability of image density and the attracting force by only controlling the concentration of the conducting agent.

In addition, as a phenomenon peculiar to the case where carbon only was used as the conducting agent, a dendritic pattern came to appear on the patch images as a result of repeated image reproduction to make accurate density undetectable. This dendritic pattern is considered to result from a sort of treeing phenomenon in which the carbon present in the vicinity of the belt surface serves as minute electrodes to cause creeping discharge on the belt surface. That is, the dendritic pattern is considered to have appeared by the following mechanism:

1. due to the occurrence of treeing, the creeping discharge areas come to have an extremely low surface resistivity;

2. the electric-field intensity acting on the toner present at the areas having come to have a low resistivity is too high;

3. the toner (patch) on the electrophotographic photosensitive member be comes unable to be transferred to the belt, so that the toner remains on the electrophotographic photosensitive member; and

4. the dendritic pattern comes to appear on the patch images.

In particular, the dendritic pattern tends to appear when, after a thermoplastic resin composition has been extruded into a film, the step of heating the film to 170° C. (the melting point of the PVDF) or more is carried out. This is considered as below.

1. As a result of being processed into a film and being again heated to the temperature not lower than the melting point of the PVDF, crystals on generated in the step of extrusion into the film become fused first.

2. When crystals of PVDF become fused and then recrystallized, the carbon is released from crystals of PVDF resin to agglomerate, and the resultant agglomerates serve as electrodes to trigger the creeping discharge.

As stated above, in controlling the resistivity of PVDF, the type and amount of the conducting agent to be added were changed to appropriately select the resistivity of a belt that can achieve both the attracting force and the stability of image density during repeated image reproduction, but it was found that no belt satisfying both of them exists. In particular, where the carbon was used as the conducting agent, there was such a disadvantage that the dendritic pattern appeared. From this fact, it has turned out that only adjusting the electrical resistivity to an appropriate value is insufficient in order to achieve both the attracting force and the stability of image density during repeated image reproduction, and another measure must be adopted which has not been elucidated.

As for another measure, in order to control the resistivity of the belt, there is no way other than using existent conducting agents unless any novel conducting agent is discovered. However, even if combining a plurality of conducting agents which show the same tendency in respect of their quantities (the polka dot pattern appears when added in a small quantity, and the attracting force lowers when added in a large quantity) and have no point of achieving both the attracting force and the prevention of the polka dot pattern, the two can not be considered to be rendered achievable. That is, even if any existent conducting agents are appropriately combined, it seems to be impossible to achieve both the attracting force and the stability of image density during repeated image reproduction.

Nevertheless, the present inventors have continued extensive studies on the combination of various conducting agents. As a result, it has turned out that, when the carbon and the polyether ester amide are used in combination, there are combinations capable and incapable of achieving both the attracting force and the stability of image density during repeated image reproduction. Accordingly, they further continued studies on this combination. As a result, it has turned out that both the attracting force and the stability of image density during repeated image reproduction are achievable only when the carbon is added in a 4- to 50-fold quantity based on the quantity of the polyether ester amide added. Further, like experiments have been conducted also in cases where the polyether ester amide is changed for a polyolefin ether and for a polyether amide. In those cases as well, it has turned out that both the attracting force and the stability of image density during repeated image reproduction are achievable only when the carbon is added in a 4- to 50-fold quantity based on the quantity of the polyolefin ether or polyether amide added. Then, like experiments have been conducted also in a case where any two of the polyether ester amide, the polyolefin ether and the polyether amide are picked out and used in combination and a case where all of these three are used in combination. As a result of such experiments, it has turned out that a good belt is obtainable only when the content (A) of the carbon added is 4- to 50-fold based on the total content (B) of these three added. That is, both the attracting force and the stability of image density during repeated image reproduction are achievable where the belt is used as a transfer material transport belt. Where the belt is used as an intermediate transfer belt, both the property to prevent the re-transfer detailed later and the stability of image density during repeated image reproduction are achievable.

In the resin composition used in the present invention, the carbon is in a fairly larger content than the polyether ester amide (PEEA), the polyolefin ether (POE) and/or the polyether amide (PEA). Hence, it has been apprehended that the dendritic pattern may appear in the patch images as a result of repeated use. However, it has turned out that such a phenomenon does not occur. Then, it has also turned out that the dendritic pattern does not appear even when, after a thermoplastic resin composition has been extruded into a film, the step of heating (again heating) the film to 170° C. (the melting point of the PVDF) is carried out.

As the reason why the dendritic pattern does not appear, the following two may be considered.

1. When the PVDF is crystallized in the step of extrusion into the belt, the PEEA, POE and/or PEA added in a very small quantity inhibit(s) the crystallization of PVDF. As long as the crystals of PVDF are in a small quantity, the carbon incorporated therein is also in a small quantity. Therefore, even when this film is again heated and the crystallization of PVD takes place, the carbon driven out of the crystals is in a small quantity. Hence, the carbon is kept from agglomerating, and the creeping discharge is kept from being triggered with ease.

2. The PEEA, POE and/or PEA has or have a lower resistivity than the PVDF. Hence, even if the creeping discharge has occurred, the electric charges are quickly eliminated by the PEEA, POE and/or PEA dispersed in a island-in-sea state in the PVDF (sea), and the discharge is prevented from continuing. That is, even if the creeping discharge has occurred, it disappears immediately, and hence, the areas having come to have a low resistivity are retained in a region that is so minute as not to affect the patch images.

If the above presumed mechanism is correct, the numerical value of A/B at which the effect of preventing the dendritic pattern is obtained is expected to have an upper limit. Accordingly, the present inventors have conducted studies on this point. As a result, it has turned out that the effect of preventing the dendritic pattern is obtained only when the value of A/B is 50 or less. It is considered to be not accidental that both the upper limit value of A/B at which both the attracting force and the stability of image density during repeated image reproduction are achievable and the upper limit value of A/B at which the effect of preventing the dendritic pattern is obtained have been found to be 50. This is considered to show that the electrical properties of the resin composition are changed with A/B=50 as a border.

As having been described above, it has been found that, where the belt is used as a transfer material transport belt, both the attracting force and the stability of image density during repeated image reproduction are achievable and also the dendritic pattern does not appear in the patch images after repeated use only when the value of A/B is 4 to 50. It has further been found that, where the belt is used as an intermediate transfer belt, the property to prevent the re-transfer detailed later and the stability of image density during repeated image reproduction are achievable and also the dendritic pattern does not appear in the patch images after repeated use only when the value of A/B is in the range of from 4 to 50. Thus, the present inventors have arrived at the present invention.

In addition, it is unclear why both the attracting force and the stability of image density during repeated image reproduction can be achieved by setting the value of A/B within a specific range (4≦A/B≦50) in the resin composition used in the present invention. The present inventors have the following hypothesis.

That is, in order to prevent the polka dot pattern, it is considered favorable to use a belt which can not easily been charged or a belt which can be de-charged at a high speed. On the other hand, in order to improve the attracting force, it is considered favorable to use a belt which can be de-charged at a low speed.

From this fact, it is considered that a belt which can not easily been charged and can be, de-charged at a low speed is favorable in order to prevent the polka dot pattern and also improve the attracting force.

In the resin composition used in the present invention, the carbon is dispersed. The carbon is not dispersed in a state in which its particles are completely separated to have primary particle diameters, but exists in a state in which its particles are fused to come to be clusters of grapes (what is called aggregates). Then, as being well-known, even if the clusters of carbon are not in direct contact with one another, electric charges flow as long as the aggregates are close to one another. Here, the electric charges must jump over the PVDF to flow, and hence must climb over some potential barriers. That is, whether or not the movement of electric charges is effected is considered to depend on the distance between the aggregates of carbon themselves and the electric-field intensity. Here, where the carbon is mixed with the PEEA, POE and/or PEA, the PEEA, POE and/or PEA dispersed in an island-in-sea state enter the spaces between the aggregates of carbon. Then, it is considered that, probably, the potential barriers between aggregates of carbon which are adjacent to one another are changed at the time the content of the PEEA, POE and/or PEA has satisfied the stated proportion with respect to the content of the carbon. As a result, probably, any excess electric charges are quickly removed. However, when de-charging has progressed to a certain extent, it becomes difficult for the electric charges to further move, so that the properties of the resin composition have greatly changed to electrical properties such that appropriate electric charges remain. The point of the present invention is the value of A/B. Therefore, even though the PEEA, POE and/or PEA dispersed in an island-in-sea has or have entered the spaces between the aggregates of carbon, in a case where the PEEA, POE and/or PEA is/are in a too larger content than the carbon (A/B<4), the mechanism of conduction is substantially the same as in a case where only the PEEA, POE and/or PEA is/are simply added. Then, although the excess electric charges are quickly removed, such electrical properties that appropriate electric charges remain are not obtainable. That is, as having experimentally been ascertained in the beginning by using only the PEEA, POE and/or PEA, both the attracting force and the stability of image density during repeated image reproduction can not be achieved. Also, in a case where the PEEA, POE and/or PEA is/are in a too small content than the carbon (A/B>50), too, only the same properties as in the case where only carbon is added are obtained. Then, although the excess electric charges are quickly removed, such electrical properties that appropriate electric charges remain are not obtainable. Thus, in this case as well, both the attracting force and the stability of image density during repeated image reproduction can not be achieved.

As stated above, the mechanism of conduction changes only when the specific conducting agent(s), the carbon and the PEEA, POE and/or PEA, are used in combination and also the content mass ratio (A/B) is within the specific range. Thus, it is considered to make it possible to achieve both the attracting force and the stability of image density during repeated image reproduction.

In the foregoing, the properties of the transfer material transport belt have been described. When used as an intermediate transfer belt, the belt of the present invention can prevent the polka dot pattern from appearing at the time of the patch detecting correction, and also can obtain the effect not obtainable in conventional cases, such that the re-transfer can be reduced.

This is considered as stated below.

In the electrophotographic apparatus using the intermediate transfer belt, too, the patch detecting correction is performed as in the electrophotographic apparatus using the transfer material transport belt. Hence, the properties of causing no polka dot pattern in the patch images are required also in both the intermediate transfer belt and the transfer material transport belt. Then, as stated previously, in order to prevent the polka dot pattern in the patch images, it is effective for the belt to have a low resistivity so that it can be de-charged at a high speed. In the case of the intermediate transfer belt, the function to attract the paper is unnecessary, but the re-transfer may seriously occur if the belt is made to have a low resistivity.

In particular, in a high-temperature and high-humidity environment, the belt tends to have a low resistivity, and hence the re-transfer may conspicuously occur to greatly lower the image density. Thus, in the case of the intermediate transfer belt, it is very difficult to achieve both the prevention of the polka dot pattern in the patch images and (especially in a high-temperature and high-humidity environment) the prevention of the re-transfer.

However, in the case where the belt of the present invention is used as the intermediate transfer belt, the properties of quickly removing excess electric charges while retaining appropriate electric charges are brought about, as stated previously. This makes it possible to achievement of both the prevention of the polka dot pattern in the patch images and (especially in a high-temperature and high-humidity environment) the prevention of the re-transfer.

Further, a polyhydric alcohol type nonionic surface-active agent such as condensed ricinoleic acid polyglycerol ester or polyglycerol stearic ester may be added to the above formulation. This can achieve both the attracting force and the stability of image density during repeated image reproduction at a much higher order.

The true reason is unclear why such a polyhydric alcohol type nonionic surface-active agent contributes to the achievement of both the attracting force and the stability of image density during repeated image reproduction, and is presumed as stated below. That is, the PVDF has a structure in which its molecule is greatly polarized and is higher in affinity for surface-active agents than other resins. The surface-active agents include anionic ones, cationic ones and nonionic ones. The anionic surface-active agents and the cationic surface-active agents, when added to the PVDF, act as ionic conducting agents upon electrolytic dissociation (ionization) of the surface-active agents. As a result, they bring about a lowering of the attracting force. On the other hand, the nonionic surface-active agents not dissociate into ions. Moreover, as long as they are of a polyhydric alcohol types, oxygen atoms of the surface-active agent and hydrogen atoms of the PVDF may readily undergo hydrogen bonding, and afford superior compatibility. Hence, as long as the polyhydric alcohol large quantity, it is supposed not to be released from the PVDF and not to move to the surface or back of the belt, but to be present in the sectional direction of the belt in a substantially uniform concentration. It is considered that, probably, the presence of this surface-active agent changes the potential barrier of the belt to more easily bring out the properties of quickly removing excess electric charges and retaining appropriate electric charges.

Studies have further been made on the content mass ratio (C/A) of the content (C) of the polyhydric alcohol type nonionic surface-active agent to the content (A) of the carbon. As a result, it has turned out that the effect exhibited by the polyhydric alcohol type nonionic surface-active agent is small when the value of C/A is less than 0.01.

It has also turned out that, when the value of C/A is more than 0.3, the attracting force and the stability of image density during repeated image reproduction is not so much different from a case in which the polyhydric alcohol type nonionic surface-active agent is not added.

Such a phenomenon that the upper limit of the content of the polyhydric alcohol type nonionic surface-active agent to be added depends on its proportion to the content of the carbon has been unexpected. Probably, the polyhydric alcohol type nonionic surface-active agent and the carbon are both present at non-crystal portions of the PVDF. Hence, it is considered that, probably, the potential barriers between aggregates of carbon which are adjacent to one another change due to the presence of the polyhydric alcohol type nonionic surface-active agent between the aggregates. From the results of the foregoing, it has turned out that a preferable range of C/A is from 0.01 or more to 0.3 or less.

Preferred embodiments for producing the belt of the present invention are described next.

In the present invention, the PVDF (polyvinylidene fluoride) refers to a homopolymer of vinylidene fluoride and a copolymer obtained by the copolymerization of vinylidene fluoride with a comonomer. The comonomer used in the copolymerization may include propylene hexafluoride and tetrafluoroethylene. The comonomer may be in a content of approximately from 5 to 15 mole %. However, in order to achieve both the attracting force and the property to prevent the polka dot pattern, the homopolymer has been found to be more advantageous. In the homopolymer of vinylidene fluoride, portions composed of head-to-head bonds and portions composed of head-to-tail bonds are mixed in many cases. Their proportions, however, by no means influence the effect of the present invention.

the carbon preferably used in the present invention may include carbon black such as acetylene black, furnace black and channel black. Of the carbon blacks, the acetylene black having good dispersibility is particularly preferred in order for the appearance of the belt not to be damaged. Also, only the above carbon black may be used as the carbon. However, the carbon black and graphite powder having an average particle diameter of from 1 to 20 μm may be used in combination. This is preferred because the stability of image density is further improved.

The reason is uncertain why the use of graphite powder in combination with carbon black improves the stability of image density. In general, the carbon black is approximately from 0.01 to 0.1 μm in primary particle diameter, whereas the graphite powder used preferably in the present invention is as large as 1 to 20 μm in particle diameter. Accordingly, the reason is considered to be probably that the graphite powder functions as a means for connecting the aggregates of the carbon black to de-charge the belt at a high speed under a high electric-filed intensity.

How to determine the average particle diameter of the graphite powder is described below.

First, as shown in FIG. 11A, the belt is sliced at a plane parallel to the belt surface. The sliced plane is set at the middle position with respect to the thickness direction of the belt. The sliced plane is observed just above it with a scanning electron microscope (SEM) (FIG. 11B). It is observed at such a magnification that about fifty to one hundred (50 to 100) graphite particles are observable in the observation visual field of the scanning electron microscope. From among the graphite particles present in the visual field defined for the observation, thirty (30) graphite particles are picked out at random. Each observed area of the thirty graphite particles picked out (the area as observed on the scanning electron microscope) is determined. Next, the observed areas of the thirty particles thus determined are averaged as an arithmetic mean. Finally, the diameter of a circle having the same area as the arithmetic mean is calculated and the value found is regarded as the average particle diameter of the graphite powder.

How to determine the primary particle diameter of the carbon black is also described below.

First, as shown in FIG. 11A, the belt is sliced at a plane parallel to the belt surface. The sliced plane is observed on a transmission electron microscope (TEM). It is observed at such a magnification that about fifty to one hundred (50 to 100) primary particles of carbon black are observable in the observation visual field of the transmission electron microscope. From among the primary particles of carbon black present in the visual field defined for the observation, thirty (30) primary particles of carbon black are picked out at random. The observed area of each particle picked out (the area as observed on the transmission electron microscope) is determined. Next, the observed areas of the thirty particles thus determined are averaged as an arithmetic mean. Finally, the diameter of a circle having the same area as the arithmetic mean is calculated, and the value found is regarded as the primary particle diameter of the carbon black.

Where the carbon black and the graphite powder are used in combination, the carbon black and the graphite powder may preferably be in a mass ratio of carbon black:graphite powder=10:90 to 90:10, assuming the total of the two to be 100. If the carbon black is in a mass of less than 10% based on the total mass of the carbon black and graphite powder, it is difficult to achieve both the attracting force and the stability of image density. The reason therefor is considered probably to be that the aggregates of carbon black are so few as to become unable to bring about the properties of quickly removing excess electric charges are quickly removed and retaining appropriate electric charges. If on the other hand the carbon black is in a mass of more than 90% based on the total mass of the carbon black and graphite powder, the effect of further stabilizing the image density in virtue of the graphite powder is no longer obtainable.

Grafted carbon black is known in which a polymer, oligomer or monomer having a reactive functional group such as an epoxy group, a glycidyl group, an oxazoline group or an amino group has been attached as a graft chain to the particle surface of carbon black, improving the dispersibility of carbon black. The polymer, oligomer or monomer having such a reactive functional group is attached as a graft chain to the particle surface of carbon black by utilizing chemical reaction with a free radical, a carboxyl group, etc., present on the particle surface of carbon black.

However, according to studies made by the present inventors, as compared with non-grafted carbon black, the grafted carbon black has been found to be not so preferable from the viewpoint of achieving both the attracting force and the property to prevent the polka dot pattern. The reason therefor is uncertain, but considered probably to be that due to a change in the dispersion state of the carbon black and the presence of the graft chain between the carbon black and the polyvinylidene fluoride, the interfacial energy is converted to have an influence on the electrical properties of the resin composition to be obtained.

The polyether ester amide (PEEA) used in the present invention is a block copolymer consisting of a polyamide block unit such as polyamide 6, polyamide 66, polyamide 11 or polyamide 12 and a polyether ester unit. Then, it is a copolymer derived from a) a lactam having 6 or more carbon atoms or a salt of aminocarboxylic acid, b) polyethylene glycol and c) a dicarboxylic acid having 4 to 20 carbon atoms. The dicarboxylic acid includes, e.g., terephthalic acid, isophthalic acid and adipic acid.

The polyether amide (PEA) used in the present invention is a block copolymer consisting of a polyamide block unit such as polyamide 6, polyamide 66, polyamide 11 or polyamide 12 and a polyether unit. Then, it refers substantially to a copolymer composed chiefly of polyethylene glycol diamine and a dicarboxylic acid, an aliphatic diamine or Σ-caprolactam.

The polyolefin ether (POE) used in the present invention is a block polymer having a structure wherein blocks of polyolefin and blocks of a polymer having a polyoxyethylene chain are repeatedly alternately linked. The linkage of the block of polyolefin and the block of the polymer having a polyoxyethylene chain is made up through at least one linkage selected from the group consisting of an ester linkage, an amide linkage, an ether linkage of and an imide linkage. In the block of polyolefin, a polyolefin having at both terminals a carbonyl group (preferably a carboxyl group), a hydroxyl group and an amino group are usable.

Next, the present inventors have made further detailed studies on the preferable content of each of the polyvinylidene fluoride, the carbon, the polyether ester amide, the polyolefin ether and the polyether amide. It has turned out that a preferable range exists for each of them.

More specifically, the polyvinylidene fluoride may preferably be in a content M of from 50.0 to 97.9% by mass based on the total mass of the resin composition used in producing the belt. If it is less than 50.0% by mass, the belt cleanability which is a preferable property of the polyvinylidene fluoride may be difficult to bring about. If it is more than 97.9% by mass, the crystallizability the polyvinylidene fluoride has may strongly appear, resulting in the great dimensional change of the belt to be produced by extrusion. In that case, it comes necessary to broaden the dimensional tolerance range of a stretch-over unit of the belt, and hence this is not preferable from the viewpoint of making electrophotographic apparatus compact.

The carbon may preferably be in a content A of from 2 to 15% by mass based on the total mass of the resin composition used in producing the belt. If it is less than 2% by mass, the conducting paths may be insufficient to lessen the effect of preventing the polka dot pattern. If it is more than 15% by mass, the belt may become brittle to have low durability. The value of A/B may preferably be in the range of from 6 to 20.

At least one resin selected from the group consisting of the polyether ester amide, the polyolefin ether and the polyether amide may preferably be in a content B of from 0.1 to 1.8% by mass based on the total mass of the resin composition used in producing the belt. If it is less than 0.1% by mass, the belt approximates substantially to a belt compounded with only the carbon. Thus, in the case of the transfer material transport belt, it is difficult to achieve both the attracting force and the stability of image density during repeated image reproduction. In the case of the intermediate transfer belt, it is difficult to achieve both the property of preventing the re-transfer and the stability of image density during repeated image reproduction. If on the other hand the resin is more than 1.8% by mass, the properties of the polyether ester amide, the polyolefin ether and/or the polyether amide may strongly appear. Thus, in the case of the transfer material transport belt, it is difficult to achieve both the attracting force and the stability of image density during repeated image reproduction. In the case of the intermediate transfer belt, it is a difficult to achieve both the property to prevent the re-transfer and the stability of image density during repeated image reproduction. The content of the polyether ester amide, the polyolefin ether and/or the polyether amide may most preferably be in the range of form 0.1 to 0.9% by mass based on the total mass of the resin composition used in producing the belt.

The polyhydric alcohol type nonionic surface-active agent used in the present invention may preferably include the following: Glycerol fatty ester (a compound obtained by the esterification reaction of glycerol with a fatty acid), pentaerythritol fatty ester (a compound obtained by the esterification reaction of pentaerythritol with a fatty acid), sorbitol fatty ester (a compound obtained by the esterification reaction of D-sorbitol with a fatty acrid), and sorbitan fatty ester (a compound obtained by the esterification reaction of sorbitan with a fatty acid).

Of these, the glycerol fatty ester is readily compatible with the PVDF, and makes it easy to achieve both the attracting force and the stability of image density during repeated image reproduction.

The glycerol fatty esters may include, as preferred examples, condensed ricinoleic acid polyglycerol ester and polyglycerol stearic ester.

The condensed ricinoleic acid polyglycerol ester is a compound obtained by the esterification reaction of condensed ricinoleic acid formed by condensation of ricinoleic acid, with polyglycerol. The polyglycerol is a compound obtained by polymerizing glycerol, where, since its polymerization degree has distribution, it is a mixture also containing glycerol or diglycerol having a low polymerization degree and is chiefly composed of glycerol having a polymerization degree of from 3 to 10 and cyclic polyglycerol.

The polyglycerol stearic ester is a compound obtained by the esterification reaction of stearic acid with polyglycerol. The polyglycerol is also a compound obtained by polymerizing glycerol, where, since its polymerization degree has distribution, it is a mixture also containing glycerol or diglycerol having a low polymerization degree, and is chiefly composed of glycerol having a polymerization degree of from 3 to 10 and cyclic polyglycerol.

In the present invention, an electrolyte may also be added in a small quantity. As preferred electrolytes, metal salts having a perfluoroalkyl group may be cited, and as the most preferred electrolyte, potassium perfluorobutanesulfonate may be cited. In the case where the electrolyte is added, it may preferably be added in an amount of 1.0% by mass or less based on the total mass of the resin composition used in producing the belt. If it is added in an amount of more than 1.0% by mass, the attracting force lowers in the case of the transfer material transport belt, and the re-transfer may seriously occur in the case of the intermediate transfer belt to make it difficult to achieve both the property of preventing the re-transfer and the property of preventing the polka dot pattern (the stability of image density during repeated image reproduction).

In the present invention, a filler may also be added, such as zinc oxide not subjected to conductive treatment, titanium oxide not subjected to conductive treatment, talc, mica and silica. The addition of a filler to the polyvinylidene fluoride tends to make the belt brittle. However, the zinc oxide, even though added, can not easily make the belt-brittle, and is particularly preferred. Further, the zinc oxide has found to be effective in preventing the polka dot pattern from appearing. The reason therefor is considered probably to be that the zinc oxide not subjected to conductive treatment has insulating properties, but a high electric field is moderated because of varistor properties the zinc oxide has, so that the belt potential can be kept from rising in excess. Thus, the particle surfaces of the zinc oxide not subjected to conductive treatment may be subjected to hydrophobic-treatment with a compound having a siloxane bond, such as a silane coupling agent or dimethylsilicone oil, whereby zinc oxide particles do not easily adsorb water, and hence the environmental dependence of belt resistivity can be lowered. As a result, it is preferable that a lowering of paper attracting force in a high-temperature and high-humidity environment can be minimized. The filler may be added in an amount of 40% by mass or less based on the total mass of the resin composition used in producing the belt. The filler may most preferably be added in an amount ranging from 1 to 15% by mass.

In addition to the polyvinylidene fluoride and the PEEA, POE and/or PEA, other thermoplastic resin or thermosetting resin may further be added as long as the effect of the present invention is not adversely affected.

Such a resin may include, e.g., the following: Polyolefin, an ethylene-vinyl alcohol copolymer (EVOH), polystyrene, polyacrylonitrile, ABS resin, polyacetal, methacrylic resins, modified polyphenylene ethers, polysulfone, polyether sulfone, polyamide-imide, thermoplastic polyimide, polyether ether ketone, aromatic polyketones, polymethylpentene, and fluorine resins (such as an ethylene-tetrafluoroethylene copolymer, a tetrafluoroethylene-perfluoroalkyl vinyl ether copolymer, a fluoroethylene-propylene copolymer, and tetrafluoroethylene).

In the belt of the present invention, in obtaining the belt using the polyhydric alcohol type nonionic surface-active agent, the effect of achieving both the attracting force and the stability of image density during repeated image reproduction, which results from the addition of the polyhydric alcohol type nonionic surface-active agent, is enhanced by;

previously melt-kneading the PVDF, the carbon and the polyhydric alcohol type nonionic surface-active agent (primary kneading), followed by pulverization to obtain a pulverized product;

then melt-kneading the pulverized product and the PEEA, POE and/or PEA (secondary kneading) to obtain a kneaded product; and

melt-extruding the kneaded product to obtain an extruded product in the shape of a tube.

The reason therefor is considered probably to be that the carbon and the polyhydric alcohol type nonionic surface-active agent are sufficiently compatible with each other at the time of the primary kneading, thereby easily bringing about the properties of quickly removing excess electric charges and retaining appropriate electric charges.

In carrying out the above primary kneading, an apparatus such as a kneader or Banbury mixer may be used as a kneading machine. Where the kneader is used, there are no particular limitations on the shape of mixing blades of the kneader, and usable are a Z type (also called a Σ type), an H type, a fish tail type and a dispersion'type. In carrying out the primary kneading, first, an empty kneader is heated at 170 to 200° C. Then, pellets of the PVDF are put into it, and agitated and mixed. At the time the PVDF has melted, the carbon and the polyhydric alcohol type nonionic surface-active agent are little by little added thereto, during which the carbon and the polyhydric alcohol type nonionic surface-active agent may preferably be continued being added until the carbon concentration comes to 15 to 40% by mass. If the carbon concentration in the primarily kneaded product is less than 15% by mass, the primarily kneaded product has so low a melt viscosity that it is difficult for the dispersion of the carbon black to proceed, thereby reducing the effect, brought about by carrying out the step of primary kneading, of establishing in a high level the attracting force and the stability of image density during repeated image reproduction. If on the other hand the carbon concentration in the primarily kneaded product is more than 40% by mass, heat may be generated so greatly at the time of the primary kneading that the PVDF may come thermally decomposed before the kneading proceeds sufficiently.

There are no particular limitations on kneading time, which may preferably be approximately from 30 minutes to 5 hours. If the kneading time is less than 30 minutes, it is difficult to obtain the effect, brought about by carrying out the step of primary kneading, of achieving both the attracting force and the stability of image density during repeated image reproduction; the effect being brought by going through the step of primary kneading. If the kneading time is more than 5 hours, thermal deterioration of the PVDF may proceed to tend to cause a lowering of the mechanical strength of the resin composition. In addition, as the kneader, a pressure type kneader may preferably be used because the melt kneading is promoted.

The primarily kneaded product thus obtained is pulverized, and then the pulverized product obtained, the PVDF and the PEEA, POE and/or PEA are secondarily kneaded. The secondarily kneaded product obtained is first cooled to make it into pellets. The pellets are processed into the belt by melt extrusion. As a kneading machine used at the time of the secondary kneading, a commonly available single-screw or twin-screw extruder may be used. The PEEA, POE and/or PEA is/are added for the first time at a time point of the secondary kneading. Hence, in order to disperse the PEEA, POE and/or PEA more uniformly in the resin composition, it is more preferable to, use a twin-screw extruder than a single-screw extruder.

The pellets obtained through the secondary kneading may preferably be extruded into a tube by melt extrusion, using a circular die, to produce the belt. Of the melt extrusion using a circular die, in particular, blown-film extrusion (inflation) may be carried out. This makes it easy to bring about the effect of achieving both the attracting force and the stability of image density during repeated image reproduction, which is a characteristic feature of the resin composition used in the present invention. In the blown-film extrusion, a tube formed by extrusion from the circular die is cooled while being stretched in both the peripheral direction and the axial direction. Hence, the PEEA, POE and/or PEA dispersed in an island-in-sea state in the resin composition extend(s) chiefly in the axial direction (the direction of extrusion=MD direction) and appropriately in the peripheral direction (TD direction) to be slender in shape. Probably, this is considered to effectively ant and bring about the properties of quickly removing excess electric charges and retaining appropriate electric charges.

As extrusion conditions for the blown-film extrusion, the blow ratio (the proportion of the diameter of a tube in a solidified state to the outer diameter of a lip of the circular die) may preferably be set at 1.2 to 3.5. If the blow ratio is set at more than 3.5, the carbon-to-carbon distance in the belt may be so large as to tend to cause the polka dot pattern. If the blow ratio is set at less than 1.2, the tube is stretched in the peripheral direction in so small an extent that the effect of rendering the PEEA, POE and/or PEA appropriately come(s) slender in shape as a result of the blown-film extrusion may be difficult to bring about. In the blown-film extrusion, the tube formed by extrusion is taken off with pinch rolls, where it may preferably be taken off at a speed of from 3 to 20 m/minute. If this take-off speed is lower than 3 m/minute, the tube diameter may come not to be stable, so that the blown-film extrusion may become very unstable. If the take-off speed is higher than 20 m/minute, melt fracture tends to occur, so that the uniformity of the carbon-to-carbon distance may be lost to tend to cause the polka dot pattern. The take-off speed may more preferably be in the range of from 5 to 15 m/minute.

Die temperature at the time of extrusion is set at 190 to 270° C. If the die temperature is lower than 190° C., the PEEA, POE and/or PEA in the resin composition can not readily be dispersed in a fine island-in-sea state because the PEEA, POE and/or PEA has or have properties of rapidly having high viscosity on the low-temperature side. As a result, it is difficult to achieve both the attracting force and the stability of image density during repeated image reproduction. If the die temperature is higher than 270° C., the PEEA, POE and/or PEA tend(s) to undergo thermal decomposition.

The belt of the present invention may preferably have an average thickness of from 60 to 130 μm. If the belt has an average thickness of less than 60 μm, it may lack strength to tend to break during running. If the belt has an average thickness of more than 130 μm, it may have a high electrostatic capacity to tend to increase belt potential when it passes through the nip between it and the electrophotographic photosensitive member, tending to cause the polka dot pattern. If in order to prevent this the conducting agent is added in a large quantity, the attracting force lowers in the case of the transfer material transport belt, and the re-transfer may seriously occur in the case of the intermediate transfer belt to make it difficult to achieve both the property to prevent the re-transfer and the property to prevent the polka dot pattern. The belt may more preferably have an average thickness in the range of from 70 to 120 μm.

The belt of the present invention may preferably have a volume resistivity in the range of from 2×10¹⁰ Ωcm to 5×10¹⁴ Ωcm as measured by the measuring method described below. If its volume resistivity is lower than 2×10¹⁰ Ωcm, the attracting force lowers when the belt is used as the transfer material transport belt. Hence, this is disadvantageous when used in electrophotographic apparatus having no attracting roller. Also, the re-transfer tends to occur as the intermediate transfer belt, and this is disadvantageous. If the volume resistivity is higher than 5×10¹⁴ Ωcm, the polka dot pattern tends to appear. Without regard to the transfer material transport belt or the intermediate transfer belt, the belt may more preferably have a volume resistivity in the range of from 5×10¹⁰ Ωcm to 8×10¹³ Ωcm, and most preferably in the range of from 1×10¹¹ Ωcm to 8×10¹³ Ωcm.

The volume resistivity is measured in the following way.

Measuring Instrument

Resistance meter: Ultra-high resistance meter R8340A (manufactured by Advantest Corporation).

Sample box: Sample box TR42 for ultra-high resistance meter (manufactured by Advantest Corporation).

(The main electrode is a metal of 22 mm in diameter and 10 mm in thickness, and the guard-ring electrode is a metal of 41 mm in inner diameter, 49 mm in outer diameter and 10 mm in thickness.)

Sample

A circular test piece of 56 mm in diameter is cut out from the belt. The test piece cutout is provided, on its one side, with an electrode over the whole surface by Pt—Pd vacuum deposition and, on the other side, concentrically provided with a main electrode film of 25 mm in diameter and a guard ring electrode film of 38 mm in inner diameter and 50 mm in outer diameter by likewise forming Pt—Pd deposited films. In addition, the Pt—Pd deposited films are formed by carrying out vacuum deposition for 2 minutes using Mild Sputter E1030 (manufactured by Hitachi Ltd.) at an electric-current value of 15 mA. The test piece for which the vacuum deposition has been completed is used as a measuring sample. In the measurement, a main electrode of 22 mm in diameter is placed on the main electrode film of 25 mm in diameter so as not to protrude therefrom. Also, a guard ring electrode of 41 mm in inner diameter is placed on the guard ring electrode film of 38 mm in inner diameter and 50 mm in outer diameter so as not to protrude therefrom.

Measurement Conditions

Measurement atmosphere: 23° C./55% RH.

(The measuring sample is previously left standing in the measurement atmosphere for 24 hours.)

Measurement mode: Program mode 5.

(Charge and measurement for 30 seconds, and discharge for 10 seconds.)

Applied voltage: 100 V.

Other conditions and the calculation of the volume resistivity may be based on ASTM-D257-78.

### EXAMPLES

The present invention is described below in greater detail by giving Examples.

### Example 1

Pellets formulated as shown in Table 1 were prepared by using a twin-screw extruder. Next, the pellets were put to blown-film extrusion by means of a blown-film extruder shown in FIG. 5.

In FIG. 5, reference numeral 100 denotes the twin-screw extruder; 110, a hopper from which an extrusion material is fed to the extruder; 140, a circular die; 150; a gas inlet passage; 200; an air ring; 210; air feed openings; 170, a stabilizing member; 180; pinch rollers (in pairs); and 190, cutters.

Here, as shown in FIG. 6, the air ring 200 has forty (40) cartridge heaters of 200 W each built-in on a pitch circle of 700 mm in diameter (PCD700). Two copper sheets (heat sinks) in pairs were attached to each cartridge heater in such a way that the cartridge heater is held between the copper sheets (see FIGS. 7 and 8).

As being clear from FIG. 6, the interior of the air ring 200 are not partitioned in the peripheral direction. Also, the air feed openings 210 to the air ring 200 are connected to a blowing means (a blower) (not shown), and air blown therethrough is made uniform in flow rate in the peripheral direction in the interior of the air ring 200, and goes out through a blow-off opening shown in FIG. 6.

At the start of the blown-film extrusion, all the outputs of the cartridge heaters are zero. In this state, the blown-film extrusion was started, and the wall thickness in the peripheral direction of the tube obtained was measured. Then, a fixed value (an intercept B) was subtracted in such a way that the power supplied (calorific value) to a cartridge heater at a position corresponding to the measurement phase came into a linear relation with the measured wall thickness value, i.e., subtracted from the thickness of the tube at each measurement phase. Then, the value found by multiplying this value by a proportionality coefficient A was defined as the output of the heater at a position corresponding to each measurement phase, and the heater was allowed to generate heat (feedback control). Through this operation, the precision of the wall thickness in the peripheral direction of the tube obtained by blown-film extrusion was improved. In this Example, the time of heater-ON time was changed setting 5 seconds for one cycle, to control the power supplied to the heaters. For example, where the out put is 30%, the heater-ON time is 1.5 seconds and the heater-OFF time is 3.5 seconds, which is repeated. Of course, the voltage applied to the heaters may be set to be variable, thereby controlling the power supplied to the heaters.

The stabilizing member 170 was so adjusted that its lower end came to the height at which it came into contact with the tube after the tube formed by extrusion solidified. The circular die 140 had a die lip of 100 mm in outer diameter and 98.4 mm in inner diameter. The molten resin composition was extruded from the die lip in a circular form (tubular), and the air was introduced in the interior of the tube, whereby, in the course of take-off, the tube was made to inflate to have a diameter of about 153 mm. Therefore, the blow ratio in this Example was 1.53 (153 mm divided by 100 mm). Also, the take-off speed of the tube by pinch rolls 180 was set at 9 m/minute. The tube thus taken off was cut with the cutters 190 in a given length.

The tube obtained by the blown-film extrusion (extrusion tube) has folds, and hence they must be removed. First, an inner form was prepared having on its outer peripheral surface a tube made of PFA (perfluoro-alkoxyfluoro resin) (PFA tube) and so structured as to be able to seal the PFA tube at its both ends to make the interior of the PFA tube air-tight. The outer periphery of the inner form was covered with the extrusion tube. Further, this outer periphery was covered with a cylinder (outer form) of 0.5 mm in wall thickness, made of nickel. In addition, the outer form was previously coated on its outer peripheral surface with a black heat-resistant coating material so that far infrared radiation was able to be absorbed to heat the outer form quickly.

After the outside of the inner form was covered with the extrusion tube, compressed air at 0.4 MPa was fed to the interior of the inner form to inflate the PFA tube on the inner-form outer peripheral surface to bring the outer peripheral surface of the PFA tube into close contact with the inner peripheral surface of the extrusion tube, and at the same time bring the outer peripheral surface of the extrusion tube into close contact with the outer form made of nickel. In this state, the outer-form outer peripheral surface was heated (again heated) with a halogen heater to 175° C., and thereafter cooled to 30° C. Through this operation, crystals of PVDF which were formed in the blown-film extrusion step were first melted, and the PVDF was re-crystallized.

After the cooling was completed, the compressed air enclosed in the interior of the inner form was discharged to release the close contact of the extrusion tube with the inner form and outer form, and then the extrusion tube was taken out.

Through the foregoing operation, the folds of the extrusion tube became disappeared. Next, a meandering preventive guide was attached to the inner peripheral surface of the tube, and the tube was cut in its width to obtain a belt of 480 mm in peripheral length, 245 mm in width and 100 μm in thickness.

The belt obtained was set in the electrophotographic apparatus shown in FIG. 4, as a transfer material transport belt 24.

In FIG. 4, symbols 1-Y, 1-M, 1-C and 1-BK denote drum-shaped electrophotographic photosensitive members (hereinafter also “photosensitive drum(s)”) serving as image bearing members, which are each rotatively driven in the direction of an arrow at a prescribed peripheral speed (process speed). All the four photosensitive drums are 24 mm in outer diameter. The rotating shafts of the four photosensitive drums are disposed substantially on a straight line, and the centers of the rotating shafts of the photosensitive drums adjacent to one another are kept 45 mm apart from one another.

The electrophotographic apparatus shown in FIG. 4 has no attracting roller. However, since the belt of the present invention has good transfer material attracting force, color aberration does not seriously occur even though the straight line connecting the rotating shaft of the first-color photosensitive drum (1-Y in the case of FIG. 4) and the rotating shaft of the fourth-color photosensitive drum (1-BK in the case of FIG. 4) is at an angle of 45 to 135 degrees to the horizontal line. In this Example; this angle was set at 80 degrees.

As to the resistance value (surface resistivity) of each transfer roller 22, a resistance value of from 1×10⁶ to 1×10⁹Ω (note: the unit of surface resistivity is Ω, and no Ωcm.) may be used. In this Example, used was a transfer roller of 5×10⁷Ω. In addition, to measure the resistance of the transfer roller, an instrument shown in FIG. 9 was used.

In FIG. 9, an aluminum cylinder is 24 mm in outer diameter, and is rotatively be driven so as to be 50 mm/second in peripheral speed. A transfer roller 22 is placed on the aluminum cylinder. To both ends of a shaft of the transfer roller 22, a load of 500 gf each is applied. Thus, the transfer roller 22 is kept in contact with the aluminum cylinder and is rotated following the rotation of the aluminum cylinder. In the state of this rotation, a DC voltage of +1,000 V is applied from a high-voltage power source to the mandrel of the transfer roller 22. Next, potential difference between both ends of detected resistance (1 kΩ) is read with a voltmeter connected to the aluminum cylinder on its downstream side. From this potential difference, the value of electric current flowing in the circuit (the value of electric current flowing in the aluminum cylinder) is calculated, and the applied voltage (1,000 V) is divided by this current value to calculate the resistance value of the transfer roller 22. The resistance is measured in an environment of 23° C./55% RH after the FIG. 9 instrument and the measuring object are left standing in the environment of 23° C./55% RH for 24 hours or more.

A process through which a first-color component image (e.g., a yellow-color component image) is formed is described below with reference to FIG. 1.

While rotating, a photosensitive drum 1-Y is uniformly charged to stated polarity and potential by means of a primary charging assembly 2, and then exposed to imagewise exposure light 3 emitted from an imagewise exposure means (not shown). Thus, an electrostatic latent image corresponding to a first-color component image (in this example, a yellow component image) is formed thereon.

Subsequently, the electrostatic latent image is developed by means of a first-color developing assembly (yellow developing assembly) 41 into a yellow component toner image. Thus, the first-color (yellow) toner image is formed on the photosensitive drum 1-Y. Then, second-color to fourth-color toner images are also formed on photosensitive drums 1-M, 1-C and 1-BK at given timing.

Meanwhile, a transfer material transport belt 24 is rotatively driven in the direction of an arrow at substantially the same peripheral speed as the photosensitive drum or with a stated difference in peripheral, speed with respect to the photosensitive drum (in many cases, the peripheral speed of the transfer material transport belt is higher than that of the photosensitive drum). Then, a transfer material P is fed to the transfer material transport belt 24 through a paper feed roller 11. The transfer material P is attracted to the transfer material transport belt 24, and the transfer material P is transported as the transfer material transport belt 24 is rotated.

When the transfer material P passes through transfer nips of the belt (the zones where the photosensitive drums and transfer rollers 22 stand face to face via the transfer material transport belt 24), transfer bias is applied to the transfer rollers 22 through bias power sources 28, whereupon the toner images on the electrophotographic photosensitive members are sequentially transferred onto the transfer material P. That is, first the first-color component (yellow toner image), then the second-color component (magenta toner image), then the third-color component (cyan toner image) and finally the fourth-color component (black toner image) are sequentially transferred on to the transfer material P while the transfer material P is transported. The transfer bias at this point is, e.g., approximately from −3 kV to +3 kV, which may differ depending on the polarities of toners (the transfer bias is set at polarity different from each toner). The transfer material transport belt 24 is cleaned by what is called an electrostatic cleaning system, in which bias having the same polarity as that of each toner is applied to each transfer roller 22 to return the toners on the transfer material transport belt 24 to the electrophotographic photosensitive member. In addition, the electrophotographic photosensitive members 1-Y to 1-BK each had a charge transport layer of 20 μm in thickness, and the primary charging and the exposure were so performed that potential (Vd) before the imagewise exposure became −600 V and potential (Vl) after the imagewise exposure became −150 V. The transfer material transport belt was moved at a speed of 50 mm/second. As the toners, negative toners of a non-magnetic one-component type were used.

The foregoing is the operation outline of the electrophotographic apparatus.

Next, evaluation was made on the polka dot pattern, the color aberration and the rear-end horizontal lines in the following way.

Evaluation on Polka Dot Pattern

In place of direct examination of the stability of image density during repeated image reproduction, evaluation was made on the polka dot pattern. Testing was carried out in an environment of 23° C./55% RH. In additon, the evaluation was made after an electrophotographic apparatus in which the transfer material transport belt was set beforehand was left standing in that environment for 24 hours or more.

First, in respect of respective colors, toner images (patch images) of 20 mm square each in size were transferred in lines on the belt. Of course, no transfer material was used at this point. That is, toner images formed on the electrophotographic photosensitive member were directly transferred onto the transfer material transport belt. In addition, development bias was so controlled that the density on the belt, of each of four-color patch images (toner laid-on quantity on belt), came to be 0.3±0.1 mg/cm². Transfer bias was set at +1,300 V for all colors.

Immediately after the four-color patch images were completely transferred onto the transfer material transport belt, the power source of the electrophotographic apparatus was turned-off, and the density uniformity of the patch images held on the transfer material transport belt was visually ascertained. Evaluation criteria of the polka dot pattern are as shown below. The results of evaluation are shown in Table 7.

A: No polka dot pattern appears at all.

B: The polka dot pattern is seen to have slightly appeared, but is not distinguishable without a stare. The output of a sensor for reading patch density was measured, resulting in the same output as in the case where normal patch density was read.

C: The polka dot pattern is seen which is distinguishable even without a stare, but it was slight. The output of a sensor for reading patch density was measured, resulting in the same output as in the case where normal patch density was read.

D: The polka dot pattern is clearly seen. The output of a sensor for reading patch density was measured, resulting in output different from the case where normal patch density was read.

Evaluation on Color Aberration

As the first item on which the paper attracting force directly influences image quality, evaluation was made on the color aberration. Testing was carried out in an environment of 23° C./80% RH. In addition, the evaluation was made after an electrophotographic apparatus in which the transfer material transport belt was set and two kinds of transfer materials shown below were beforehand left standing in that environment for 24 hours or more.

In addition, the transfer materials were wrapped by 250 sheets or 500 sheets as one volume, where, in order for the paper to sufficiently absorb moisture, these were unwrapped and so left that 10 sheets or more of paper did not pile up and the resultant sheets of paper were used.

First, as shown in FIG. 10, at the middle part of a transfer material, black, yellow, magenta and cyan horizontal lines each 100 μm in line width (the thickness of a line) and 5 mm in length were arranged at intervals of 5 mm horizontally in a row. Regarding the line composed of 4-color horizontal lines as one line, 130 rows in total were drawn at intervals of 2 mm in the lengthwise direction of the sheet to form an image having four columns of black (BK), yellow (Y), magenta (M) and cyan (C), and this image was reproduced. (The top and bottom ends of an A4 sheet was left blank in about 20 mm width and image reproduction was carried out at the middle area of 258 mm in length. The drawing position was at the middle area of the sheet width in the right-and-left directions.) Next, in each row, how much the cyan, magenta and yellow horizontal lines are deviated in the lengthwise direction was measured on the basis of the black horizontal line in terms of absolute values. The maximum value of the absolute values was regarded as the value of color aberration at that row. Then, the maximum value of the values of color aberration at all rows of from the first row to the 130th row was regarded as color aberration level (μm) in that page. In the present invention, when merely referred to as “color aberration”, it indicates this “color aberration level (μm) in the page”.

Such evaluation was made in respect of the following two kinds of paper.

Sheet 1: CLC (Color Laser Copier) sheet (available from CANON SALES CO., INC.; A4 size; basis weight: 81.4 g/m²).

Sheet 2: CLC thick-gage sheet NS700 (available from CANON SALES CO., INC.; A4 size; basis weight: 157 g/m²).

In addition, the transfer bias was changed in value in the following way, depending on the paper used.

Where CLC sheet (basis weight: 81.4 g/m²) was used: +800 for the four colors.

Where CLC thick-gage sheet (basis weight: 157 g/m²) was used: +900 for the four colors.

The reason why the transfer bias was set a little higher in the case of thick-gage sheet is that the paper has a higher resistivity as the paper has a larger thickness and hence a higher transfer bias is necessary in order for the toner to be well transferred.

Judgement criteria according to the color aberration level are, without regard to the kind of paper, as shown below. The results of evaluation are shown in Table 7.

A: 200 μm or less.

B: More than 200 μm to 220 μm or less.

C: More than 220 μm to 240 μm or less.

D: More than 240 μm to 260 μm or less.

DD: More than 260 μm.

Rear-End Horizontal Lines

As the second item on which the paper attracting force influences image quality directly, evaluation was made on the rear-end horizontal lines. Testing was carried out in an environment of 30° C./80% RH. In addition, the evaluation was made after an electrophotographic apparatus in which the transfer material transport belt was set and two kinds of transfer materials shown above were beforehand left in that environment for 24 hours or more.

In addition, the transfer materials are wrapped by 250 sheets or 500 sheets as one volume, where, in order to make the paper sufficiently absorb moisture, these were unwrapped and so left that 10 sheets or more of paper did not pile up, and the resultant sheets of paper were used.

First, a latent-image pattern in which one-dot exposure ON in a horizontal line and two-dot exposure OFF in a horizontal line are repeated at 600 dpi was formed on the photosensitive drum 1-BK by exposure, and this was printed under usual conditions for image reproduction to reproduce black halftone images. When the rear end of a sheet passes through the nip between the belt and the third photosensitive drum 1-C and the transfer material has become nipped only at the fourth photosensitive drum 1-BK, the rear end of the sheet may flap during the transfer of black images if the transfer material transport belt has low attracting force, so that the rear-end horizontal lines may appear (as density non-uniformity in the shape of horizontal lines). In this Example, the distance between the rotational shafts of the electrophotographic photosensitive members adjacent to one another is 45 mm, and hence the rear-end horizontal lines appear at the position of about 45 mm from the rear-end of the transfer material.

In addition, as in the evaluation on the color aberration, the transfer bias was changed in value, depending on the paper used.

Where CLC sheet (basis weight: 81.4 g/m²) was used: +800 (v) for the four colors.

Where CLC thick-gage sheet (basis weight: 157 g/m²) was used: +900 (v) for the four colors.

The reason why the transfer bias was set a little higher in the base of thick-gage sheet is the same as that stated in the evaluation on the color aberration.

The density non-uniformity appeared in horizontal lines on the transfer material was visually evaluated.

Judgement criteria are, without regard to the kind of paper, as shown below. The results of evaluation are shown in Table 7.

A: No rear-end horizontal line appears.

B: The rear-end horizontal lines are seen to have slightly appeared, but are not distinguishable without a stare.

C: The rear-end horizontal lines are seen which are distinguishable even without a stare, but are slight.

D: The rear-end horizontal lines are clearly seen.

### Example 2

A belt was produced in the same manner as in Example 1 except that the formulation was changed as shown in Table 1. Evaluation was made in the same way.

The results are shown in Table 7. In this Example, the value of A/B was 50, and hence, compared with Example 1, the prevention of the polka dot pattern and the attracting force (prevention of color aberration and rear-end horizontal lines) were each at an inferior level.

A very slight dendritic pattern was also seen on the patch images after 10,000-sheet running (extensive operation), but was not at a level in which the patch density was incorrectly read. Hence, the stability of the image density was on a level with that at the initial stage.

### Example 3

A belt was produced in the same manner as in Example 1 except that the formulation was changed as shown in Table 1 and the thickness 100 μm was changed to 60 μm. Evaluation was made in the same way. The results are shown in Table 7.

### Example 4

A belt was produced in the same manner as in Example 1 except that the formulation was changed as shown in Table 1. Evaluation was made in the same way. The results are shown in Table 7. In this Example, the PEEA content was 1.8% by mass, which was a little larger, and moreover the carbon content to the PEEA (A/B) was 4, which was a little smaller, and hence, compared with Example 3, the prevention of polka dot pattern and the attracting force (prevention of color aberration and rear-end horizontal lines) were each at an inferior level.

### Example 5

A belt was produced in the same manner as in Example 1 except that the formulation was changed as shown in Table 1 and the thickness 100 μm was changed to 130 μm. Evaluation was made in the same way. The results are shown in Table 7.

### Example 6

A belt was produced in the same manner as in Example 1 except that the formulation was changed as shown in Table 1. Evaluation was made in the same way. The results are shown in Table 7.

### Example 7

A belt was produced in the same manner as in Example 1 except that the formulation was changed as shown in Table 1. Evaluation was made in the same way. The results are shown in Table 7.

### Example 8

A belt was produced in the same manner as in Example 1 except that the formulation was changed as shown in Table 1. Evaluation was made in the same way. The results are shown in Table 7. In this Example, the value of A/B was 20, and hence the dendritic pattern was not seen at all in the patch images after 10,000-sheet running.

### Example 9

A belt was produced in the same manner as in Example 1 except that the formulation was changed as shown in Table 1. Evaluation was made in the same way. In this Example, the PEEA and the POE were mixed. Also, two types of carbon were used. The results are shown in Table 7.

### Example 10

A belt was produced in the same manner as in Example 1 except that the formulation was changed as shown in Table 1. Evaluation was made in the same way. The results are shown in Table 7. In this Example, the filler was added in a large quantity, and hence, slight cracking of the belt was seen after 10,000-sheet running.

### Example 11

A belt was produced in the same manner as in Example 1 except that the formulation was changed as shown in Table 1. Evaluation was made in the same way. The results are shown in Table 7. In this Example, the filler was added in a quantity smaller than that in Example 10, and hence, no cracking of the belt was seen after 10,000-sheet running.

### Production Example 1

Production of Grafted Carbon:

| | (by mass) | |
|---|---|---|
| Styrene as a monomer for graft chains | 70 | parts |
| Butyl methacrylate | 20 | parts |
| Glycidyl methacrylate | 8.5 | parts |
| Carbon tetrachloride as a chain transfer agent | 0.5 | part |
| Azobisisobutyronitrile as a radical generator | 1 | part |

To a mixture of the above, 100 parts by mass of an aqueous 1% polyvinyl alcohol solution was added. The resulting mixture was introduced into a reaction vessel fitted with a stirrer and a nitrogen feed pipe, and, keeping the interior of the reaction vessel at 80° C. in a stream of nitrogen, allowed to polymerize for 10 hours with vigorous stirring. The polymerization product obtained was filtered, washed, and then dried to obtain a polymer for graft chains. Then 100 parts by mass of the polymer for graft chains and 15 parts by mass of furnace black (MA100R, available from Mitsubishi Chemical Corporation) were kneaded for 30 minutes by means of a kneader kept at 180° C., producing a grafted carbon.

### Example 12

A belt was produced in the same manner as in Example 1 except that the grafted carbon obtained in Production Example 1 was used and the formulation was changed as shown in Table 1. Evaluation was made in the same way. The results are shown in Table 7.

In this Example, the grafted carbon was used, and hence the prevention of polka dot pattern and the attracting force (prevention of color aberration and rear-end horizontal lines) were each at a level inferior to those in other Examples.

The reason therefor is considered to be that since the carbon particles surfaces were coated with graft chains, interfacial energy between the carbon and the polyvinylidene fluoride was changed and affected the electrical properties of the belt to make it difficult to achieve both the prevention of polka dot pattern and the attracting force (prevention of color aberration an rear-end horizontal lines).

### Example 13

A belt was produced in the same manner as in Example 1 except that the formulation was changed as shown in Table 2. Evaluation was made in the same way. The results are shown in Table 7. In this Example, the value of A/B was 20, and hence the dendritic pattern was not seen at all in the patch images after 10,000-sheet running.

### Example 14

A belt was produced in the same manner as in Example 1 except that the formulation was changed as shown, in Table 2. Evaluation was made in the same way. In this Example, the value of A/B was 50, and hence, a very slight dendritic pattern was seen on the patch images after 10,000-sheet running, but was not at a level in which the patch density was incorrectly read. The results are shown in Table 7.

### Example 15

A belt was produced in the same manner as in Example 1 except that the formulation was changed as shown in Table 2. Evaluation was made in the same way. The results are shown in Table 7.

### Example 16

A belt was produced in the same manner as in Example 1 except that the formulation was changed as shown in Table 2. Evaluation was made in the same way. The results are shown in Table 7.

### Example 17

A belt was produced in the same manner as in Example 5 except that its thickness was changed to 150 μm. Evaluation was made in the same way. In this Example, the belt thickness was as large as 150 μm, and hence the belt had a small electrostatic capacity. This caused the polka dot pattern at a level inferior to that in Example 5. The results are shown in Table 7.

### Example 18

A belt was produced in the same manner as in Example 1 except that the formulation was changed as shown in Table 2. Evaluation was made in the same way. The results are shown in Table 7.

### Example 19

A belt was produced in the same manner as in Example 1 except that the formulation was changed as shown in Table 2. Evaluation was made in the same way. The results are shown in Table 7.

### Example 20

A belt was produced in the same manner as in Example 1 except that the formulation was changed as shown in Table 2. Evaluation was made in the same way. The results are shown in Table 7.

In the foregoing, it has been demonstrated that the belt of the present invention is favorable for the electrophotographic apparatus shown in FIG. 4. Of course, it may also be used in the electrophotographic apparatus having an attracting roller as shown in FIG. 1.

### Example 21

The belt obtained in Example 1 was set in an electrophotographic apparatus shown in FIG. 3, as its intermediate transfer belt. An electrophotographic photosensitive member 1 has a diameter of 46.7 mm. The electrophotographic photosensitive member 1 has a charge transport layer of 20 μm in thickness. Primary charging and exposure were so performed that potential (Vd) before imagewise exposure came to −600 V and potential (Vl) after imagewise exposure came to −150 V. The speed of travel of the transfer material transport belt was set at 51 mm/second, and the peripheral speed of the electrophotographic photosensitive member at 50 mm/second. As toners, negative toners of a non-magnetic one-component type were used. A primary transfer roller 6 and a secondary transfer roller 7 were the same as the transfer rollers 22 used in Example 1.

As a belt cleaning member 9, a rubber roller of 12 mm in outer diameter was used which showed a resistivity of 1×10⁷Ω as measured by the same transfer roller resistivity measuring method making use of the instrument shown in FIG. 9. To this roller, a voltage formed by superimposing on an AC voltage a DC voltage having a polarity reverse to that of the surface potential of the electrophotographic photosensitive member (here, a sinusoidal AC voltage of 2 kHz and 2 kVpp and a DC voltage of +1 kV) was applied to charge toners on an intermediate transfer belt 5 to a polarity reverse to that of the electrophotographic photosensitive member 1. By this measure, the apparatus was so set up that the toners were electrostatically transferred from the intermediate transfer belt 5 to the electrophotographic photosensitive member 1 at the contact part (nip) between the electrophotographic photosensitive member 1 and the intermediate transfer belt 5 and the vicinity thereof (electrostatic cleaning). The intermediate transfer belt 5 was cleaned by such electrostatic cleaning and prepared for the operation of image formation for making an evaluation on the polka dot pattern and for the operation of image formation for making an evaluation on the re-transfer. In addition, during the operation of image formation for making an evaluation on the polka dot pattern and during the operation of image formation for making an evaluation on the re-transfer, the belt Cleaning member 9 is kept separate from the intermediate transfer belt 5.

Evaluation was made on the polka dot pattern and the re-transfer in the following way.

Evaluation on Polka Dot Pattern

In place of direct examination of the stability of image density during repeated image reproduction, evaluation was made on the polka dot pattern. Testing was carried out in an environment of 23° C./55% RH. In addition, the evaluation was made after an electrophotographic apparatus in which the intermediate transfer belt was set beforehand was left standing in that environment for 24 hours or more.

First, in respect of respective colors, toner images (patch images) each 20 mm square in size were transferred in a line onto the intermediate transfer belt. In addition, development bias was so controlled that the density on the belt of each of four-color patch images (toner laid-on quantity on belt) came to 0.3±0.1 mg/cm². Transfer bias was set at +1,300 V for all colors.

Immediately after the four-color patch images were completely transferred onto the intermediate transfer belt, the power source of the electrophotographic apparatus was turned off before entering the step of secondary transfer, and the uniformity in density of the patch images held on the intermediate transfer belt was visually ascertained. Evaluation criteria of the polka dot pattern are as shown below. The results of evaluation are shown in Table 8.

A: No polka dot pattern appears at all.

B: The polka dot pattern is seen to have slightly appeared, but is not distinguishable without a stare. The output of a sensor for reading patch density was measured, resulting in the same output as in the case when normal patch density was read.

C: The polka dot pattern is seen which is distinguishable even without a stare, but it is slight. The output of a sensor for reading patch density was measured, resulting in the same output as in the case where normal patch density was read.

D: The polka dot pattern is clearly seen. The output of a sensor for reading patch density was measured, resulting in output different from the case where normal patch density was read.

Evaluation on Re-Transfer

Testing was carried out in an environment of 30° C./80% RH. In addition, the evaluation was made after an electrophotographic apparatus in which the intermediate transfer belt was set beforehand and Sheet 1 used in Example 1 were left in that environment for 24 hours or more. The transfer materials are wrapped by 500 sheets as one volume, where, in order for the paper to sufficiently absorb moisture, these were unwrapped and so left that 10 sheets or more of paper did not pile up, and the resultant sheets of paper were used.

The evaluation on the re-transfer was made in two evaluation modes.

Evaluation mode 1: Evaluation was started from a state in which no image reproduction was performed for 1 hour or more in the past. First, the electrophotographic apparatus was set up in a full-color mode (a mode in which subsequent secondary transfer to the transfer material is performed after the intermediate transfer belt has rotated four times), where a first-color, yellow solid image was transferred from the electrophotographic photosensitive member to the intermediate transfer belt (first-time rotation). In addition, the development bias of yellow toner was so controlled that the toner laid-on quantity on the electrophotographic photosensitive member came to 0.6±0.1 mg/cm². Primary transfer bias was set at +800 V. At the time the primary transfer of the yellow toner was completed and the intermediate transfer belt entered the second-time rotation (the step of second-color primary transfer), the power source of the electrophotographic apparatus was turned off to stop all operation. In addition, as to the second color, no imagewise exposure was performed on the electrophotographic photosensitive member. The yellow toner re-transferred onto the electrophotographic photosensitive member was taken off onto a colorless and transparent polyester tape provided with a pressure-sensitive adhesive, and stuck to Sheet 1. As a comparison control for detecting the density of the re-transferred toner, the same polyester tape as the above with no toner adhered thereto was also stuck to Sheet 1. Image density on the polyester tape to which the yellow toner was adhered and image density on the polyester tape to which no toner was adhered were read with a Macbeth densitometer (RF914, manufactured by Gretag Macbeth AG). The difference in density between the two was regarded as an index of the re-transfer.

Evaluation mode 2: Continuous printing on 11 sheets was performed in a full-color mode. On the first 10 sheets, printing was performed in the state that no imagewise exposure was made at all on the electrophotographic photosensitive member (solid white images) in respect of all colors. In respect of the first color (yellow) on the 11th sheet, flash exposure was made on the electrophotographic photosensitive member, and the development bias of yellow toner was so controlled that the toner laid-on quantity on the electrophotographic photosensitive member came to 0.6±0.1 mg/cm², where the solid images were transferred from the electrophotographic photosensitive member to the intermediate transfer belt, (first-time rotation). In respect of the second color, no exposure was made at all. At the time the primary transfer of the yellow toner was completed and the intermediate transfer belt entered the second-time rotation (the step of second-color primary transfer), the power source of the electrophotographic apparatus was turned off to stop all operation.

In addition, primary transfer bias in Evaluation mode 2 was all set at +800 V, and secondary transfer bias at +1,500 V. The density of the yellow toner re-transferred onto the electrophotographic photosensitive member was measured and evaluated in the same manner as in Evaluation mode 1.

The results of evaluation are shown in Table 8. In addition, evaluation criteria in Table 8 are as shown below.

A: The density is less than 0.02.

B: The density is, 0.02 or more to less, than 0.05.

C: The density is 0.05 or more to less than 0.1.

D: The density is 0.1 or more. Influence on image density and color tones is great.

### Example 22

The belt obtained in Example 1 was set in an electrophotographic apparatus shown in FIG. 2, as its intermediate transfer belt 5. Electrophotographic photosensitive members 1-Y to 1-BK each have a charge transport layer of 20 μm in thickness. Primary charging and exposure were so performed that potential (Vd) before imagewise exposure came to −600 V and potential (Vl) after imagewise exposure came to −150 V. The electrophotographic photosensitive members 1-Y to 1-BK each have an outer diameter of 24 mm. The speed of travel of the transfer material transport belt 5 was set at 51 mm/second, and the peripheral speed of the electrophotographic photosensitive member at 50 mm/second. As toners, negative toners of a non-magnetic one-component type were used. As a primary transfer roller 6 and a secondary transfer roller 7, the same ones as the transfer rollers 22 used in Example 1 were used. As a belt cleaning member 9, the same one as in Example 21 was used. The voltage applied to the rollers was also set as in Example 21 so as to perform electrostatic cleaning of the intermediate transfer belt In addition, as in Example 21, during the operation of image formation for making an evaluation on the polka dot pattern and during the operation of image formation for making an evaluation on the re-transfer, the belt cleaning member 9 is kept separate from the intermediate transfer belt 5.

Evaluation was made on the polka dot pattern and the re-transfer in the following way.

Evaluation on Polka Dot Pattern

In place of direct examination of the stability of image density during repeated image reproduction, evaluation was made on the polka dot pattern. Testing was carried out in an environment of 23° C./55% RH. In addition, the evaluation was made after an electrophotographic apparatus in which the intermediate transfer belt was set beforehand was left in that environment for 24 hours or more.

First, in respect of respective colors, toner images (patch images) each 20 mm square in size were transferred in a line onto the intermediate transfer belt. In addition, development bias was so controlled that the density on the belt of each of four-color patch images, (toner laid-on quantity on belt) came to 0.3±0.1 mg/cm². Transfer bias was set at +1,300 V for all colors.

Immediately after the four-color patch images were completely transferred onto the intermediate transfer belt, the power source of the electrophotographic apparatus was turned off before entering the step of secondary transfer, and the uniformity in density of the patch images held on the intermediate transfer belt was visually ascertained. Evaluation criteria of the polka dot pattern are the same as those in Example 21. The results of evaluation are shown in Table 8.

Evaluation on Re-Transfer

Tested in an environment of 30° C./80% RH. In addition, the evaluation was made after an electrophotographic apparatus in which the intermediate transfer belt was set beforehand and Sheet 1 used in Example 1 were left standing in that environment for 24 hours or more. The transfer materials are wrapped by 500 sheets as one volume, where, in order to make the paper sufficiently absorb moisture, these were unwrapped and so left that 10 sheets or more of paper did not pile up, and the resultant sheets of paper were used.

The evaluation on the re-transfer was made in two evaluation modes.

Evaluation mode 1: Evaluation was started from a state in which no image reproduction was performed for 1 hour or more in the past. In respect of the first color (yellow), flash exposure was made on the electrophotographic photosensitive member. In respect of the second color (magenta), no exposure was made. In addition, the development bias of yellow toner was so controlled that the toner laid-on quantity on the electrophotographic photosensitive member came to 0.6±0.1 mg/cm². Primary transfer bias was set at +800 V. At the time the primary transfer of the yellow toner was completed and the intermediate transfer belt entered the second-time rotation (the step of second-color primary transfer), the power source of the electrophotographic apparatus was turned off to stop all operation. In addition, as to the second color, no imagewise exposure was performed on the electrophotographic photosensitive member. The density of the yellow toner re-transferred onto the electrophotographic photosensitive member was measured and evaluated in the same manner as in Example 21.

Evaluation mode 2: Continuous printing on 11 sheets was performed in a full-color mode. On the first 10 sheets, printing was performed in the state that no imagewise exposure was made at all on the electrophotographic photosensitive member (solid white images) in respect of all colors. In respect of the first color (yellow) on the 11th sheet, flash exposure was made on the electrophotographic photosensitive member, and the solid images were transferred from the electrophotographic photosensitive member to the intermediate transfer belt (first-time rotation). In addition, the development bias of yellow toner was so controlled that the toner laid-on quantity on the electrophotographic photosensitive member came to 0.6±0.1 mg/cm². In respect of the second color, no exposure was made at all. At the time the primary transfer of the yellow toner was completed and the intermediate transfer belt entered the second-time rotation (the step of second-color primary transfer), the power source of the electrophotographic apparatus was turned off to stop all operation.

Primary transfer bias in Evaluation mode 2 was all set at +800 V, and secondary transfer bias at +1,500 V. The density of the yellow toner re-transferred onto the electrophotographic photosensitive member was measured and evaluated in the same manner as that in Evaluation mode 1.

The results of evaluation are shown in Table 8.

### Comparative Example 1

A belt was produced in the same manner as in Example 1 except that the formulation was changed as shown in Table 2. Evaluation was made in the same way. The results are shown in Table 7. In this Comparative Example, only the PEEA was used as the conducting agent, and hence it was unable to achieve both the prevention of polka dot pattern and the attracting force (prevention of color aberration and rear-end horizontal lines).

### Comparative Example 2

A belt was produced in, the same manner as in Example 1 except that the formulation was changed as shown in Table 2. Evaluation was made in the same way. The results are shown in Table 7. In this Comparative Example, only the carbon was used as the conducting agent, and hence it was unable to achieve both the prevention of polka dot pattern and the attracting force (prevention of color aberration and rear-end horizontal lines). The dendritic pattern was also seen in the patch images after 10,000-sheet running, resulting in a poor stability of image density as compared with the one at the initial stage.

### Comparative Example 3

A belt was produced in the same manner as in Example 1 except that the formulation was changed as shown in Table 2. Evaluation was made in the same way. The results are shown in Table 7. In this Comparative Example, the volume resistivity was the same as in Example 4, but, since the value of A/B was as small as 3, only the same properties as in Comparative Example 1 in which only the PEEA was added, were obtained.

### Comparative Example 4

A belt was produced in the same manner as in Example 1 except that the formulation was changed as shown in Table 2. Evaluation was made in the same way. The results are shown in Table 7. In this Comparative Example, the volume resistivity was the same as that in Example 4, but, since the value of A/B was as large as 55, only the same properties as those in Comparative Example 2 in which only the carbon was added, were obtained. The dendritic pattern was also seen in the patch images after 10,000-sheet running, resulting in a poor stability of image density as compared with the one at the initial stage.

### Comparative Example 5

A belt was produced in the same manner as in Example 1 except that the formulation was changed as shown in Table 2. Evaluation was made in the same way. The results are shown in Table 7. The results of evaluation in this Comparative Example were equal to the results of evaluation in Comparative Example 1 in which only the PEEA was added. The reason therefor is considered to be that the value of A/B in this Comparative Example was as small as 1.43 and hence the effect brought by the PEEA became substantially predominant.

### Comparative Example 6

A belt was produced in the same manner as in Example 1 except that the formulation was changed as shown in Table 2. Evaluation was made in the same way. The results are shown in Table 7. The results of evaluation in this Comparative Example were equal to the results of evaluation in Comparative Example 1 in which only the PEEA was added. The reason therefore is considered to be that the value of A/B in this Comparative Example was as small as 1.43 and hence the effect brought by the PEEA became substantially predominant.

### Comparative Example 7

The belt of Comparative Example 3 was set in the electrophotographic apparatus shown in FIG. 3, as the intermediate transfer belt, and evaluation was made in the same manner as in Example 21. The results of evaluation are shown in Table 8.

### Comparative Example 8

The belt of Comparative Example 4 was set in the electrophotographic apparatus shown in FIG. 3, as the intermediate transfer belt, and evaluation was made in the same manner as in Example 21. The results of evaluation are shown in Table 8. The dendritic pattern was also seen in the patch images after 10,000-sheet running, resulting in a poor stability of image density compared with the one at the initial stage.

### Comparative Example 9

The belt of Comparative Example 3 was set in the electrophotographic apparatus shown in FIG. 2, as the intermediate transfer belt, and evaluation was made in the same manner as in Example 22. The results of evaluation are shown in Table 8.

### Comparative Example 10

The belt of Comparative Example 4 was set in the electrophotographic apparatus shown in FIG. 2, as the intermediate transfer belt, and evaluation was made in the same manner as in Example 22. The results of evaluation are shown in Table 8. The dendritic pattern was also seen in the patch images after 10,000-sheet running, resulting in a poor stability of image density compared with the one at the initial stage.

### Example 23

Carbon and a polyhydric alcohol type nonionic surface-active agent were kneaded in PVDF, followed by pulverization to make up two kinds of pulverized products (those of primary-kneaded products) previously.

Pulverized Product 1: A pressure type kneader made empty was heated to 200° C., and 69.7 kg of pellets of PVDF were introduced into it, and mixed by stirring to make the PVDF fuse. Next, 5 kg of carbon black (a powdered product of DENKA BLACK) and 50 g of a polyhydric alcohol type nonionic surface-active agent (TYRABAZOLE H-818) were introduced into the kneader, and the kneader was closed, where its contents were melt-kneaded for 6 minutes. This operation (the introduction of the carbon black and polyhydric alcohol type nonionic surface-active agent and the melt kneading) was carried out six times in total. Therefore, the materials introduced finally into the kneader were 69.7 kg of the PVDF, 30 kg of the carbon black and 300 g of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 8 minutes. Then, the kneader was again opened, and the melt-kneaded product was cooled at room temperature until it came to have a temperature of 230° C. Thereafter, the kneader was closed, and the kneaded product cooled was melt-kneaded for 8 minutes. At this stage, the melt-kneaded product was at a temperature of 270° C. The total kneading time after first introducing the carbon black was 52 minutes. The temperature of the melt-kneaded product was so controlled as not to become higher than 270° C.; If the temperature is made higher than this, the PVDF begins to decompose, and hence the belt using this may have a low mechanical strength. As described above, it is better for the carbon black not to be introduced at one time but to be dividedly introduced a plurality of times. A standard of the mass of the carbon black to be added each time is 15% or less of the mass of the PVDF having been introduced in the kneader. The melt-kneaded product thus obtained was pulverized to have a size of about 2 to 5 mm by means of a guillotine cutter and a pulverizer to obtain Pulverized Product 1.

Pulverized Product 2: A pressure type kneader made empty was heated to 200° C., and 69.7 kg of pellets of PVDF were introduced into it, and mixed by stirring to fuse the PVDF. Next, 5 kg of graphite powder (UF-G10) and 50 g of a polyhydric alcohol type nonionic surface-active agent (TYRABAZOLE H-818) were introduced into the kneader, and the kneader was closed, where its contents were melt-kneaded for 7 minutes. This operation (the introduction of the graphite powder and polyhydric alcohol type nonionic surface-active agent and the melt kneading) was carried out six times in total. Therefore, the materials introduced totally into the kneader were 69.7 kg of the PVDF, 30 kg of the graphite powder and 300 g of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 9 minutes. Then, the kneader was again opened, and the melt-kneaded product was cooled at room temperature until it came to have a temperature of 230° C. Thereafter, the kneader was closed, and the kneaded product cooled was melt-kneaded for 9 minutes. At this stage, the melt-kneaded product was at a temperature of 270° C. The total kneading time after first introducing the graphite powder was 60 minutes. The temperature of the melt-kneaded product was so controlled as not to become higher than 270° C. If the temperature is made higher than this, the PVDF begins to decompose, and hence the belt using this may have a low mechanical strength. As described above, it is better for the graphite powder not to be introduced at one time but to be dividedly introduced a plurality of times. A standard of the mass of the graphite powder to be added each time is 15% or less of the mass of the PVDF having been introduced in the kneader. The melt-kneaded product thus obtained was pulverized to have a size of about 2 to 5 mm by means of a guillotine cutter and a pulverizer to obtain Pulverized Product 2.

Pulverized Product 1, Pulverized Product 2, PVDF, PEEA, zinc oxide, and zinc oxide treated with dimethylsilicone oil were so mixed as to have the formulation shown in Table 4. The mixture obtained was melt-kneaded (secondary kneading) by means of a twin-screw extruder to produce pellets. Using the resulting pellets, melt extrusion was carried out in the same manner as in Example 1 to produce a transfer material transport belt. This was evaluated inn the same manner as in Example 1.

In this Example, condensed ricinoleic acid polyglycerol ester is mixed as the polyhydric alcohol type nonionic surface-active agent in an amount of 1% ((0.072/7.2)×100) in mass ratio, based on the mass of the carbon. Hence, as compared with a belt not containing this surface-active agent, the occurrence of the polka dot pattern can be further reduced and also a high attracting force can be obtained. For example, making a comparison between this Example and Example 4 in respect of the results of the evaluation in the case where the paper of 81.4 g/m² in basis weight is used, it is seen that the prevention of polka dot pattern is improved by one rank (from B-level to A-level) and the prevention of color aberration and rear-end horizontal lines are improved even by two ranks (from C-level to A-level).

Here, where the paper used in the evaluation is thick, the color aberration and the rear-end horizontal lines occur seriously. The reason therefor is stated below. First, in the case where the paper is thick, the paper is heavy in its own weight. Hence, the color aberration tends to occur seriously unless the paper is transported while being attracted more strongly to the belt. This tendency is remarkable when the paper is upward transported against the gravity. Further, in a usual electrophotographic apparatus, between the transfer finish position and the fixing start position, the paper is so made as not to move in a straight posture, but to move while keeping a somewhat curved state (a loop). This is because, if no loop is made, the fixing assembly pulls the paper being in the course of the transfer step, only because the speed of fixing is slightly hither than the speed of transfer, which causes images to be blurred. As long as such a loop is made, the loop acts as a buffer even when the speed of fixing and the speed of transfer are not perfectly synchronized, and hence the images can be prevented from being blurred. However, in the case where the paper is thick, the paper has strong flexural rigidity, and if a loop is made, force of straightening the paper becomes large, and this force acts to slip the transfer material (or push back the transfer material) on the belt. As a result, the color aberration and the rear-end horizontal lines tend to occur.

Nevertheless, in the belt of the present invention, good results were obtainable in respect of all the polka dot pattern, the color aberration and the rear-end horizontal lines. The results are shown in Table 9.

### Example 24

Carbon and a polyhydric alcohol type nonionic surface-active agent were kneaded and incorporated into PVDF, followed by pulverization to make up two kinds of pulverized products (those of primary-kneaded products) previously.

Pulverized Product 3: A pressure type kneader made empty was heated to 200° C., and 64 kg of pellets of PVDF were introduced into it, and were mixed by stirring to fuse the PVDF. Next, 5 kg of carbon black (SEAST SP SRF-LS) and 1 kg of a polyhydric alcohol type nonionic surface-active agent (TYRABAZOLE-H-818) were introduced into the kneader, and the kneader was closed, where its contents were melt-kneaded for 12 minutes. This operation (the introduction of the carbon black and polyhydric alcohol type nonionic surface-active agent and the melt kneading) was carried out six times in total. Therefore, the materials introduced totally into the kneader were 64 kg of the PVDF, 30 kg of the carbon black and 6 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded the kneader was again opened, and the melt-kneaded product was cooled at room temperature until it came to have a temperature of 230° C. Thereafter, the kneader was closed, and the kneaded product cooled was melt-kneaded for 13 minutes. At this stage, the melt-kneaded product was at a temperature of 270° C. The total, kneading time after first introducing the carbon black was 98 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 3.

Pulverized Product 4: A pressure type kneader made empty was kept heated to 200° C., and 64 kg of pellets of PVDF were introduced into it, and mixed by stirring to fuse the PVDF fuse. Next, 5 kg of graphite powder (UF-G10) and 1 kg of a polyhydric alcohol type nonionic surface-active agent (TYRABAZOLE H-818) were introduced into the kneader, and the kneader was closed, where its contents were melt-kneaded for 13 minutes. This operation (the introduction of the graphite powder and polyhydric alcohol type nonionic surface-active agent and the melt kneading) was carried out six times in total. Therefore, the materials introduced finally into the kneader were 64 kg of the PVDF, 30 kg of the graphite powder and 6 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 15 minutes. Then, the kneader was again opened, and the melt-kneaded product was cooled at room temperature until it came to have a temperature of 230° C. Thereafter, the kneader was closed, and the kneaded product cooled was melt-kneaded for 15 minutes. At this stage, the melt-kneaded product was at a temperature of 270° C. The total kneading time after first introducint the graphite powder was 108 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 4.

Pulverized Product 3, Pulverized Product 4, PVDF, POE, zinc oxide, and zinc oxide treated with dimethylsilicone oil were so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. Here, in this Example, the belt thickness was 130 μm. The results of evaluation are shown in Table 9.

### Example 25

First, Pulverized Product 5 (a primary-kneaded product) was made up in the following way.

Pulverized Product 5: A pressure type kneader made empty was kept heated to 200° C., and 79.8 kg of pellets of PVDF were introduced into it, and were mixed by stirring to make the PVDF fuse. Next, 2.5 kg of carbon black (KETJEN BLACK EC-600JD) and 25 g of a polyhydric alcohol type nonionic surface-active agent (TYRABAZOLE H-818) were introduced into the kneader, and the kneader was closed, where its contents were melt-kneaded for 6 minutes. This operation (the introduction of the carbon black and polyhydric alcohol type nonionic surface-active agent and the melt-kneading) was carried out eight times in total. Therefore, the materials introduced totally into the kneader were 79.8 kg of the PVDF, 20 kg of the carbon black and 200 g of the polyhydric alcohol type nonionic surface-active agent. After the eighth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 8 minutes. Then, the kneader was again opened, and the melt-kneaded product was cooled at room temperature until it came to have a temperature of 230° C. Thereafter, the kneader was closed, and the kneaded product cooled was melt-kneaded for 8 minutes. At this stage, the melt-kneaded product was at a temperature of 270° C. The total kneading time after first introducing the Carbon black was 64 minutes. The temperature of the melt-kneaded product was so controlled as not to become higher than 270° C. The melt-kneaded product thus obtained was pulverized to have a size of about 2 to 5 mm by means of a guillotine cutter and a pulverizer, obtaining Pulverized Product 5.

Pulverized Product 2 as used in Example 23, Pulverized Product 5, PVDF and PEA were mixed. The mixture obtained was melt-kneaded (secondary kneading) by means of a twin-screw extruder to obtain pellets having formulation shown in Table 4. Using the pellets obtained, a transfer material transport belt was produced in the same manner as in Example 1. This was evaluated in the same manner as in Example 1. The results of evaluation are shown in Table 9.

### Example 26

Carbon and a polyhydric alcohol type nonionic surface-active agent were kneaded and incorporated into PVDF, followed by pulverization to make up two kinds of pulverized products (primary-kneaded products) previously.

Pulverized Product 6: A pressure type kneader made empty was heated to 200° C., and 67 kg of pellets of PVDF were introduced into it, and were mixed by stirring to fuse the PVDF. Next, 5 kg of carbon black (a powdered product of DENKA BLACK) and 500 g of a polyhydric alcohol type nonionic surface-active agent (TYRABAZOLE P-4) were introduced into the kneader, and the kneader was closed, where its contents were melt-kneaded for 12 minutes. This operation (the introduction of the carbon black and polyhydric alcohol type nonionic surface-active agent and the melt kneading) was carried out six times in total. Therefore, the materials introduced totally into the kneader were 67 kg of the PVDF, 30 kg of the carbon black and 3 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 13 minutes. Then, the kneader was again opened, and the melt-kneaded product was cooled at room temperature until it came to have a temperature of 230° C. Thereafter, the kneader was closed, and the kneaded product cooled was melt-kneaded for 13 minutes. At this stage, the melt-kneaded product was at a temperature of 270° C. The total kneading time after the carbon black was introduced first was 98 minutes. The temperature of the melt-kneaded product was so controlled as not to become higher than 270° C. The melt-kneaded product thus obtained was pulverized to have a size of about 2 to 5 mm by means of a guillotine cutter and a pulverizer to produce Pulverized Product 6.

Pulverized Product 7: A pressure type kneader made empty was heated to 200° C., and 67 kg of pellets of PVDF were introduced into it, and were mixed by stirring to fuse the PVDF. Next, 5 kg of graphite powder (UF-G10) and 500 of a polyhydric alcohol type nonionic surface-active agent (TYRABAZOLE P-4) were introduced into the kneader, and the kneader was closed, where its contents were melt-kneaded for 15 minutes. This operation (the introduction of the graphite powder and polyhydric alcohol type nonionic surface-active agent and the melt kneading) was carried out six times in total. Therefore, the materials introduced finally into the kneader were 67 kg of the PVDF, 30 kg of the graphite powder and 3 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 17 minutes. Then, the kneader was again opened, and the melt-kneaded product was cooled at room temperature until it came to have a temperature of 230° C. Thereafter, the kneader was closed, and the kneaded product cooled was melt-kneaded for 17 minutes. At this stage, the melt-kneaded product was at a temperature of 270° C. The total kneading time after first introducing the graphite powder was 124 minutes. The temperature of the melt-kneaded product was so controlled as not to become higher than 270° C. The melt-kneaded product thus obtained was pulverized to have a size of about 2 to 5 mm by means of a guillotine cutter and a pulverizer to produce Pulverized Product 7.

Pulverized Product 6, Pulverized Product 7, PVDF, PEEA, zinc oxide, and zinc oxide treated with dimethylsilicone oil were so mixed as to have the formulation shown in Table 4. The mixture obtained was melt-kneaded (secondary kneading) by means of a twin-screw extruder to produce pellets. Using the resulting pellets, melt extrusion was carried out in the same manner as in Examples to produce a transfer material transport belt. This was evaluated in the same manner as in Example 1. The results of evaluation are shown in Table 9.

### Example 27

Carbon and a polyhydric alcohol type nonionic surface-active agent were kneaded and incorporated into PVDF, followed by pulverization to make up two kinds of pulverized products (primary-kneaded products) previously.

Pulverized Product 8: A pressure type kneader made empty was kept heated to 200° C., and 69.4 kg of pellets of PVDF were introduced into it, and were mixed by stirring to fuse the PVDF. Next, 5 kg of carbon black (SEAST SP SRF-LS) and 100 g of a polyhydric alcohol type nonionic surface-active agent (TYRABAZOLE P-4) were introduced into the kneader, and the kneader was closed, where its contents were melt-kneaded for 12 minutes. This operation (the introduction of the carbon black and polyhydric alcohol type nonionic surface-active agent and the melt kneading) was carried out six times in total. Therefore, the materials introduced finally into the kneader were 69.4 kg of the PVDF, 30 kg of the carbon black and 600 g of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 13 minutes. Then, the kneader was again opened, and the melt-kneaded product was cooled at room temperature until it came to have a temperature of 230° C. Thereafter, the kneader was closed, and the kneaded product cooled was melt-kneaded for 13 minutes. At this stage, the melt-kneaded product was at a temperature of 270° C. The total kneading time after first introducint the carbon black was 98 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 8.

Pulverized Product 9: A pressure type kneader made empty was kept heated to 200° C., and 69.4 kg of pellets of PVDF were introduced into it, and mixed by stirring to fuse the PVDF. Next, 5 kg of graphite powder (UF-G10) and 100 g of a polyhydric alcohol type nonionic surface-active agent (TYRABAZOLE P-4) were introduced into the kneader, and the kneader was closed, where its contents were melt-kneaded for 13 minutes. This operation (the introduction of the graphite powder and polyhydric alcohol type nonionic surface-active agent and the melt kneading) was carried out six times in total. Therefore, the materials introduced totally into the kneader were 69.4 kg of the PVDF 30 kg of the graphite powder and 600 g of the polyhydric alcohol type nonionic surface-active agents. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 15 minutes. Then, the kneader was again opened, and the melt-kneaded product was cooled at room temperature until it came to have a temperature of 230° C. Thereafter, the kneader was closed, and the kneaded product cooled was melt-kneaded for 15 minutes. At this stage, the melt-kneaded product was at a temperature of 270° C. The total kneading time after first introducing the graphite powder was 108 minutes. The temperature of the melt-kneaded product was so controlled as not to become higher than 270° C. The melt-kneaded product thus obtained was pulverized to have a size of about 2 to 5 mm by means of a guillotine cutter and a pulverizer to produce Pulverized Product 9.

Pulverized Product 8, Pulverized Product 9, PVDF, POE, zinc oxide, and zinc oxide treated with dimethylsilicone oil were so mixed as to have the formulation shown in Table 4. The mixture obtained was melt-kneaded (secondary kneading) by means of a twin-screw extruder to obtain pellets. Using the pellets obtained, melt extrusion was carried out in the same manner as in Example 1 to produce a transfer material transport belt. This was evaluated in the same manner as in Example 1. The results of evaluation are shown in Table 9.

### Example 28

Carbon and a polyhydric alcohol type nonionic surface-active agent were kneaded and incorporated into PVDF, followed by pulverization to make up two kinds of pulverized products (primary-kneaded products) previously.

Pulverized Product 10: A pressure type kneader made empty was kept heated to 200° C., and 61 kg of pellets of PVDF were introduced into it, and were mixed by stirring to fuse the PVDF. Next, 5 kg of carbon black (KETJEN BLACK EC-600JD) and 1.5 kg of a polyhydric alcohol type nonionic surface-active agent TYRABAZOLE P-4) were introduced into the kneader, and the kneader was closed, where its contents were melt-kneaded for 8 minutes. This operation (the introduction of the carbon black and polyhydric a alcohol type nonionic surface-active agent and the melt-kneading) was carried out six times in total therefore, the materials introduced totally into the kneader were 61 kg of the PVDF, 30 kg of the carbon black and 9 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 10 minutes. Then, the kneader was again opened, and the melt-kneaded product was cooled at room temperature until it came to have a temperature of 230° C. Thereafter, the kneader was closed, and the kneaded product cooled was melt-kneaded for 10 minutes. At this stage, the melt-kneaded product was at a temperature of 270° C. The total kneading time after first introducing the carbon black was 68 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 10.

Pulverized Product 11: A pressure type kneader made empty was heated to 200° C., and 61 kg of pellets of PVDF were introduced into it, and were mixed by stirring to fuse the PVDF. Next, 7.5 kg of graphite powder (UF-G10) and 2.25 kg of a polyhydric alcohol type nonionic surface-active agent (TYRABAZOLE H-818) were introduced into the kneader, and the kneader was closed, where its contents were melt-kneaded for 17 minutes. This operation (the introduction of the graphite powder and polyhydric alcohol type nonionic surface-active agent and the melt kneading) was carried out four times in total. Therefore, the materials introduced totally into the kneader were 61 kg of the PVDF, 30 kg of the graphite powder and 9 kg of the polyhydric alcohol type nonionic surface-active agent. After the fourth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 15 minutes. Then, the kneader was again opened, and the melt-kneaded product was cooled at room temperature until it came to have a temperature of 230° C. Thereafter, the kneader was closed, and the kneaded product cooled was melt-kneaded for 15 minutes. At this stage, the melt-kneaded product was at a temperature of 270° C. The total kneading time after first introducing the graphite powder was 98 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 11.

Pulverized Product 10, Pulverized Product 11, PVDF, POE, PEEA, zinc oxide, and zinc oxide treated with dimethylsilicone oil were so mixed as to have formulation shown in Table 4. The mixture obtained was melt-kneaded (secondary kneading) by means of a twin-screw extruder to produce pellets. Using the resulting pellets, melt extrusion was carried out in the same manner as in Example 1 to produce a transfer material transport belt. This was evaluated in the same manner as in Example 1. The results of evaluation are shown in Table 9.

### Example 29

First, Pulverized Product 12 (primary-kneaded product) was made up in the following way.

Pulverized Product 12: A pressure type kneader made empty was heated to 200° C., and 69.7 kg of pellets of PVDF were introduced into it, and were mixed by stirring to fuse the PVDF. Next, 5 kg of carbon black (SEAST SP SRF-LS) and 50 g of a polyhydric-alcohol type nonionic surface-active agent (TYRABAZOLE H-818) were introduced into the kneader, and the kneader was closed where its contents were melt-kneaded for 6 minutes. This operation (the introduction of the carbon black and polyhydric alcohol type nonionic surface-active agent and the melt kneading) was carried out six times in total. Therefore, the materials introduced totally into the kneader were 69.7 kg of the PVDF, 30 kg of the carbon black and 300 g of the polyhydric alcohol type nonionic surface-active agent. After the sixth-time introduction and melt kneading were completed, the kneader was opened, and the melt-kneaded product was closed, and the kneaded product cooled was melt-kneaded for 8 minutes. Then, the kneader was again opened, and the melt-kneaded product was cooled at room temperature until it came to have a temperature of 230° C. Thereafter, the kneader was closed, and the kneaded product cooled was melt-kneaded for 8 minutes. At this stage, the melt-kneaded product was at a temperature of 270° C. The total kneading time after first introducing the carbon black was 52 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 12.

Pulverized Product 2 as used in Example 23, Pulverized Product 12, PVDF, PEEA, zinc oxide, and zinc oxide treated with dimethylsilicone oil were mixed. The mixture obtained was melt-kneaded (secondary kneading) by means of a twin-screw extruder, obtaining pellets having the formulation shown in Table 4. Using the pellets obtained, a transfer material transport belt was produced in the same manner as in Example 1. This was evaluated in the same manner as in Example 1. The results of evaluation are shown in Table 9.

### Example 30

Carbon and a polyhydric alcohol type nonionic surface-active agent were kneaded in PVDF, followed by pulverization to make up two kinds of pulverized products (those of primary-kneaded products) previously.

Pulverized Product 13: A pressure type kneader made empty was heated to 200° C., and 84.25 kg of pellets of PVDF were introduced into it, and were mixed by stirring to fuse the PVDF. Next, 3 kg of carbon black (KETJEN BLACK EC-600JD) and 150 g of a polyhydric alcohol type nonionic surface-active agent (TYRABAZOLE H-818) were introduced into the kneader, and the kneader was closed, where its contents were melt-kneaded for 8 minutes. This operation (the introduction of the carbon black and polyhydric alcohol type nonionic surface-active agent and the melt kneading) was carried out five times in total. Therefore, the materials introduced totally into the kneader were 84.25 kg of the PVDF, 15 kg of the carbon black and 750 g of the polyhydric alcohol type nonionic surface-active agent. After the fifth-time introduction and melt kneading were completed, the kneader was opened, and the melt-kneaded product was cooled at room temperature until it came to have a temperature of 230° C., Thereafter, the kneader was closed, and the kneaded product cooled was melt-kneaded for 9 minutes. Then, the kneader was again opened, and the melt-kneaded product was cooled at room temperature until it came to have a temperature of 230° C. Thereafter, the kneader was closed, and the kneaded product cooled was melt-kneaded for 9 minutes. At this stage, the melt-kneaded product was at a temperature of 270° C. The total kneading time after first introducing the carbon black was 58 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 13.

Pulverized Product 14: A pressure type kneader made empty was kept heated to 200° C., and 68.5 kg of pellets of PVDF were introduced into it, and were mixed by stirring to fuse the PVDF. Next, 5 kg of graphite powder (UF-G10) and 250 g of a polyhydric alcohol type nonionic surface-active agent (TYRABAZOLE H-818) were introduced into the kneader, and the kneader was closed, where its contents were melt-kneaded for 11 minutes. This operation (the introduction of the graphite powder and polyhydric alcohol type nonionic surface-active agent and the melt kneading) was carried out six times in total. Therefore, the materials introduced totally into the kneader were 68.5 kg of the PVDF, 30 kg of the graphite powder and 1.5 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 10 minutes. Then, the kneader was again opened, and the melt-kneaded product was cooled at room temperature until it came to have a temperature of 230° C. Thereafter, the kneader was closed, and the kneaded product cooled was melt-kneaded for 10 minutes. At this stage, the melt-kneaded product was at a temperature of 270° C. The total kneading time after first introducint the graphite powder was 86 minutes. The temperature of the melt-kneaded product was so controlled as not to become higher than 270° C. The melt-kneaded product thus obtained was pulverized to have a size of about 2 to 5 mm by means of a guillotine cutter and a pulverizer to produce Pulverized Product 14.

Pulverized Product 13, Pulverized Product 14, PVDF, PEEA, zinc oxide, and zinc oxide treated with dimethylsilicone oil were so mixed as to have the formulation shown in Table 4. The mixture obtained was melt-kneaded (secondary kneading) by means of a twain-screw extruder to obtain pellets. Using the pellets obtained, melt extrusion was carried out in the same manner as in Example 1 to produce a transfer material transport belt. This was evaluated in the same manner as in Example 1. The results of evaluation are shown in Table 9.

### Example 31

Pulverized Product 3 as used in Example 24, Pulverized Product 4 as used in Example 23, PVDF, POE, zinc oxide, and zinc oxide treated with dimethylsilicone oil were mixed so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. The results of evaluation are shown in Table 9.

### Example 32

Carbon and a polyhydric alcohol type nonionic surface-active agent were kneaded and incorporated into PVDF, followed by pulverization to make up two kinds of pulverized products (primary-kneaded products) previously.

Pulverized Product 15: A pressure type kneader made empty was heated to 200° C., and 82.4 kg of pellets of PVDF were introduced into it, and were mixed by stirring to make the PVDF fuse. Next, 4 kg of carbon black (KETJEN BLACK EC-600JD) and 400 g of a polyhydric alcohol type nonionic surface-active agent (TYRABAZOLE H-818) were introduced into the kneader, and the kneader was closed, where its contents were melt-kneaded for 10 minutes. This operation (the introduction of the carbon black and polyhydric alcohol type nonionic surface-active agent and the melt kneading) was carried out four times in total. Therefore, the materials introduced totally into the kneader were 82.4 kg of the PVDF, 16 kg of the carbon black and 1.6 kg of the polyhydric alcohol type nonionic surface-active agent. After the fourth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 7 minutes. Then, the kneader was again opened, and the melt-kneaded product was cooled at room temperature until it came to have a temperature of 230° C. Thereafter, the kneader was closed, and the kneaded product cooled was melt-kneaded for 7 minutes. At this stage, the melt-kneaded product was at a temperature of 270° C. The total kneading time after first introducing the carbon black was 54 minutes. The temperature of the melt-kneaded product was so controlled as not to become higher than 270° C. The melt-kneaded product thus obtained was pulverized to have a size of about 2 to 5 mm by means of a guillotine cutter and a pulverizer to produce Pulverized Product 15.

Pulverized Product 16: A pressure type kneader made empty was kept heated to 200° C., and 67 kg of pellets of PVDF were introduced into it, and were mixed by stirring to fuse the PVDF. Next, 5 kg of graphite powder (UF-G10) and 500 g of a polyhydric alcohol type nonionic surface-active agent (TYPABAZOLE H-818) were introduced into the kneader, and the kneader was closed, where its contents were melt-kneaded for 15 minutes. This operation (the introduction of the graphite powder and polyhydric alcohol type nonionic surface-active agent and the melt kneading) was carried out six times in total. Therefore, the materials introduced totally into the kneader were 67 kg of the PVDF, 30 kg of the graphite powder and 3 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 17 minutes. Then, the kneader was again opened, and the melt-kneaded product was cooled at room temperature until it dame to have a temperature of 230° C. Thereafter, the kneader Was closed, and the kneaded product cooled was melt-kneaded for 17 minutes. At this stage, the melt-kneaded product was at a temperature of 270° C. The total kneading time after first introducint the graphite powder was 124 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 16.

Pulverized Product 15, Pulverized Product 16, PVDF, PEA, zinc oxide, and zinc oxide treated with dimethylsilicone oil were so mixed as to have formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. The results of evaluation are shown in Table 9.

### Example 33

Carbon and a polyhydric alcohol type nonionic surface-active agent were kneaded and incorporate into PVDF, followed by pulverization to make up two kinds of pulverized products (those of primary-kneaded products) previously.

Pulverized Product 17: A pressure type kneader made empty was kept heated to 200° C., and 63.2 kg of pellets of PVDF were introduced into it, and were mixed by stirring to make the PVDF fuse. Next, 4 kg of carbon black (SEAST SP SRF-LS) and 600 g of a polyhydric alcohol type nonionic surface-active agent (TYRABAZOLE P-4) were introduced into the kneader, and the kneader was closed, where its contents were melt-kneaded for 8 minutes. This operation (the introduction of the carbon black and polyhydric alcohol type nonionic surface-active agent and the melt kneading) was carried out eight times in total. Therefore, the materials introduced totally into the kneader were 63.2 kg of the PVDF, 32 kg of the carbon black and 4.8 kg of the polyhydric alcohol type nonionic surface-active agent. After the eighth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 7 minutes. Then, the kneader was again opened, and the melt-kneaded product was cooled at room temperature until it came to have a temperature of 230° C. Thereafter, the kneader was closed, and the kneaded product cooled was melt-kneaded for 7 minutes. At this stage, the melt-kneaded product was at a temperature of 270° C. The total kneading time after first introducing the carbon black was 78 minutes. The temperature of the melt-kneaded product was so-controlled as not to become higher than 270° C. The melt-kneaded product thus obtained was pulverized to have a size of about 2 to 5 mm by means of a guillotine cutter and a pulverizer to obtain Pulverized Product 17.

Pulverized Product 18: A pressure type kneader made empty was heated to 200° C., and 54 kg of pellets of PVDF were introduced into it, and were mixed by stirring to fuse the PVDF. Next, 5 kg of graphite powder (UF-G10) and 750 g of a polyhydric alcohol type nonionic surface-active agent (TYRABAZOLE H-818) were introduced into the kneader, and the kneader was closed, where its contents were melt-kneaded for 10 minutes. This operation (the introduction of the graphite powder and polyhydric alcohol type nonionic surface-active agent and the melt kneading) was carried out eight times in total. Therefore, the materials introduced totally into the kneader were 54 kg of the PVDF, 40 kg of the graphite powder and 6 kg of the polyhydric alcohol type nonionic surface-active agent. After the eighth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 10 minutes. Then, the kneader was again opened, and the melt-kneaded product was cooled at room temperature until it came to have a temperature of 230° C. Thereafter, the kneader was closed, and the kneaded product cooled was melt-kneaded for 10 minutes. At this stage, the melt-kneaded product was at a temperature of 270° C. The total kneading time after first introducing the graphite powder was 100 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 18.

Pulverized Product 17, Pulverized-Product 18, PVDF, PEEA, zinc oxide, and zinc oxide treated with dimethylsilicone oil were so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. The results of evaluation are shown in Table 9.

### Example 34

First, Pulverized Product 19 (of a primary-kneaded product) was made up in the following way.

Pulverized Product 19: A pressure type kneader made empty was heated to 200° C., and 67 kg of pellets of PVDF were introduced into it, and were mixed by stirring to make the PVDF fuse. Next, 5 kg of carbon black (DENKA BLACK) and 500 g of a polyhydric alcohol type nonionic surface-active agent (TYRABAZOLE H-818) were introduced into the kneader, and the kneader was closed, where its contents were melt-kneaded for 8 minutes. This operation (the introduction of the carbon black and polyhydric alcohol type nonionic surface-active agent and the melt kneading) was carried out six times in total. Therefore, the materials introduced totally into the kneader were 67 kg of the PVDF, 30 kg of the carbon black and 3 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 8 minutes. Then, the kneader was again opened, and the melt-kneaded product was cooled at room temperature until it came to have a temperature of 230° C. Thereafter, the kneader was closed, and the kneaded product cooled was melt-kneaded for 8 minutes. At this stage, the melt-kneaded product was at a temperature of 270° C. The total kneading time after first introducing the carbon black was 64 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 19.

Next, Pulverized Product 19, PVDF, PEEA and zinc oxide were mixed, and, using a twin-screw extruder, pellets having the formulation shown in Table 4 were obtained. Using the pellets obtained, a transfer material transport belt was produced in the same manner as in Example 1. This was evaluated in the same manner as in Example 1. Here, in this Example, the belt thickness was 60 μm. The results of evaluation are shown in Table 9.

### Example 35

First, Pulverized Product 20 (primary-kneaded product) was made up in the following way.

Pulverized Product 20: A pressure type kneader made empty was heated to 200° C., and 67 kg of pellets of PVDF were introduced into it, and were mixed by stirring to fuse the PVDF. Next, 5 kg of grafted carbon black (see Production Example 1) and 500 g of a polyhydric alcohol type nonionic surface-active agent (TYRABAZOLE H-818) were introduced into the kneader, and the kneader was closed, where its contents were melt-kneaded for 6 minutes. This operation (the introduction of the grafted carbon black and polyhydric alcohol type nonionic surface-active agent and the melt kneading) was carried out six times in total. Therefore, the materials introduced totally into the kneader were 67 kg of the PVDF, 30 kg of the grafted carbon black and 3 Kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 8 minutes. Then, the kneader was again opened, and the melt-kneaded product was cooled at room temperature until it came to have a temperature of 230° C. Thereafter, the kneader was closed, and the kneaded product cooled was melt-kneaded for 8 minutes. At this stage, the melt-kneaded product was at a temperature of 270° C. The total kneading time after first introducing the grafted carbon black was 52 minutes. The temperature of the melt-kneaded product was so controlled as not to become higher than 270° C. The melt-kneaded product thus obtained was pulverized to have a size of about 2 to 5 mm by means of a guillotine cutter and a pulverizer to produce Pulverized Product 20.

Next, Pulverized Product 20, PVDF, PEEA and zinc oxide were mixed. The mixture obtained was melt-kneaded (secondary kneading) by means of a twin-screw extruder to obtain pellets having formulation shown in Table 4. Using the pellets obtained, a transfer material transport belt was produced in the same manner as in Example 1. This was evaluated in the same manner as in Example 1. This Example was the same as Example 34 in the respect that the value of A/B was 10, the value of C/A was 0.1 and the primary-kneaded product of the carbon, the polyhydric alcohol type nonionic surface-active agent and the PVDF were used. However, because of the use of the grafted carbon black, the results of evaluation were inferior to those in Example 34. The results of evaluation are shown in Table 9.

### Example 36

First, Pulverized Product 21 (of a primary-kneaded product) was made up in the following way.

Pulverized Product 21: A pressure type kneader made empty was kept heated to 200° C., and 68.5 kg of pellets of PVDF were introduced into it, and were mixed by stirring to fuse the PVDF. Next, 5 kg of carbon black (SEAST SP SRF-LS) and 250 g of a polyhydric alcohol type nonionic surface-active agent (TYRABAZOLE H-818) were introduced into the kneader, and the kneader was closed, where its contents were melt-kneaded for 8 minutes. This operation (the introduction of the carbon black and polyhydric alcohol type nonionic surface-active agent and the melt kneading) was carried out six times in total. Therefore, the materials introduced totally into the kneader were 68.5 kg of the PVDF, 30 kg of the carbon black and 1.5 kg of the polyhydric alcohol type nonionic surface-active agent. After the sixth-time introduction and melt kneading were completed, the kneader was opened, and the melt-kneaded product was cooled at room temperature until it came to have a temperature of 230° C. Thereafter, the kneader was closed, and the kneaded product cooled was melt-kneaded for 7 minutes. Then, the kneader was again opened, and the melt-kneaded product was cooled at room temperature until it came to have a temperature of 230° C. There after, the kneader was closed, and the kneaded product cooled was melt-kneaded for 7 minutes. At this stage, the melt-kneaded product was at a temperature of 270° C. The total kneading time after first introducint the carbon black was 62 minutes. The temperature of the melt-kneaded product was so controlled as not to become higher than 270° C. The melt-kneaded product thus obtained was pulverized to have a size of about 2 to 5 mm by means of a guillotine cutter and a pulverizer to obtain Pulverized Product 21.

Pulverized Product 14 as used in Example 30, Pulverized Product 21, PVDF, POE, zinc oxide, and zinc oxide treated with dimethylsilicone oil were so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. The results of evaluation are shown in Table 9.

### Comparative Example 11

Pulverized Product 19 as used in Example 34 and PVDF were so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. In this Comparative Example, only the carbon was used as the conducting agent, and hence it was unable to achieve both the prevention of polka dot pattern and the attracting force (prevention of color aberration and rear-end horizontal lines). The dendritic pattern was also seen in the patch images after 10,000-sheet running, resulting in a poor stability of image density as compared with the initial stage. The results of evaluation are shown in Table 9.

The difference between this Comparative Example and Comparative Example 2 resides in the presence or absence of the polyhydric alcohol type nonionic surface-active agent. However, as can be seen from the comparison of the evaluation results shown in Table 7 and Table 9, the evaluation results in Comparative Example 2 and in this Comparative Example are at the same level. That is, when the PEEA, POE and/or PEA was/were added, useful effects were not seen even with the addition of the polyhydric alcohol type nonionic surface-active agent.

### Comparative Example 12

Pulverized Product 19 as used in Example 34, PVDF and PEEA were so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. In this Comparative Example, the value of A/B was as small as 3, and hence it was unable to achieve both the prevention of polka dot pattern and the attracting force (prevention of color aberration and rear-end horizontal lines). The results of evaluation are shown in Table 9.

The difference between this Comparative Example and Comparative Example 3 resides in the presence or absence of the polyhydric alcohol type nonionic surface-active agent. However, as can be seen from comparison of the evaluation results shown in Table 7 and Table 9, the evaluation results in Comparative Example 3 and this Comparative Example are at the same level. That is, when the value of AB was not within the range of the present invention, useful effects were not seen even with the addition of the polyhydric alcohol type nonionic surface-active agent.

### Comparative Example 13

Pulverized Product 19 as used in Example 34, PVDF and PEEA were so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. In this Comparative Example, the value of A/B was as large as 55, and hence it was unable to achieve both the prevention of polka dot pattern and the attracting force (prevention of color aberration and rear-end horizontal lines). The dendritic pattern was also seen in the poor stability of image density as compared with the initial stage. The results of evaluation are shown in Table 9.

The difference between this Comparative Example and Comparative Example 4 resides in the presence or absence of the polyhydric alcohol type nonionic surface-active agent. However, as can be seen from the comparison of the evaluation results shown in Table 7 and Table 9, the evaluation results in Comparative Example 4 and this Comparative Example are at the same level. That is, when the value of A/B was not within the range of the present invention, useful effects were not seen even with the addition of the polyhydric alcohol type nonionic surface-active agent.

### Comparative Example 14

Pulverized Product 19 as used in Example 34, PVDF and PEEA were so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt This was evaluated in the same manner as in Example 1. In this Comparative Example, the value of A/B was as small as 1.43, and hence it was unable to achieve both the prevention of polka dot pattern and the attracting force (prevention of color aberration and rear-end horizontal lines). The results of evaluation are shown in Table 9.

The difference between this Comparative Example and Comparative Example 5 resides in the presence or absence of the polyhydric alcohol type nonionic surface-active agent. However, as can be seen from the comparison of the evaluation results shown in Table 7 and Table 9, the evaluation results in Comparative Example 5 and this Comparative Example are at the same level. That is, when the value of A/B was not within the range of the present invention, any useful effects were not seen even with the addition of the polyhydric alcohol type nonionic surface-active agent.

### Comparative Example 15

Pulverized Product 20 as used in Example 35, PVDF and PEEA were so mixed as to have the formulation shown in Table 4. The mixture obtained was melt-kneaded (secondary kneading) by means of a twin-screw extruder, obtaining pellets. Using the pellets obtained, melt extrusion was carried out in the same manner as in Example 1 to produce a transfer material transport belt. This was evaluated in the same manner as in Example 1. In this Comparative Example, the value of A/B was as small as 1.43, and hence it was unable to achieve both the prevention of polka dot pattern and the attracting force (prevention of color aberration and rear-end horizontal lines). The results of evaluation are shown in Table 9.

The difference between this Comparative Example and Comparative Example 6 resides in the presence or absence of the polyhydric alcohol type nonionic surface-active agent. However as can be seen from the comparison of the evaluation results shown in Table 7 and Table 9, the evaluation results in Comparative Example 6 and this Comparative Example are at the same level. That is, when the value of A/B was not within the range of the present invention, useful effects were not seen even with the addition of the polyhydric alcohol type nonionic surface-active agent.

### Example 37

A belt obtained in the same manner as in Example 26 was set in the electrophotographic apparatus shown in FIG. 3, as its intermediate transfer belt. Evaluation was made in the same manner as in Example 21. The results of evaluation are shown in Table 10.

In this Example, the polyhydric alcohol type nonionic surface-active agent was added, and hence the re-transfer did not seriously occur even when the CLC thick-gage sheet was used. The addition of the polyhydric alcohol type nonionic surface-active agent has brought about such properties that excess electric charges are quickly removed, and hence positive electric charges imparted to the intermediate transfer belt by the secondary transfer roller hardly remain even when a high voltage is applied to the secondary transfer roller. That is, if such excess positive electric charges remain on the intermediate transfer belt, the potential difference between the electrophotographic photosensitive member and the intermediate transfer belt becomes too large in the step of next-color primary transfer, so that an excess transfer current may flow to cause the re-transfer seriously. However, in the case of this Example, no such a problem occurs.

### Example 38

A belt obtained in the same manner as in Example 26 was set in the electrophotographic apparatus shown in FIG. 2, as its intermediate transfer belt. Evaluation was made in the same manner as in Example 22. The results of evaluation are shown in Table 10.

In this Example, the polyhydric alcohol type nonionic surface-active agent was added, and hence the re-transfer did not seriously occur even when the CLC thick-gage sheet was used. The addition of the polyhydric alcohol type nonionic surface-active agent has brought about such properties that excess electric charges are quickly removed, and hence positive electric charges imparted to the intermediate transfer belt by the secondary transfer roller hardly remain even when a high voltage is applied to the secondary transfer roller. That is, if such excess positive electric charges remain on the intermediate transfer belt, the potential difference between the electrophotographic photosensitive member and the intermediate transfer belt becomes too large in the step of next-color primary transfer, so that an excess transfer current may flow to cause the re-transfer seriously. However, in the case of this Example, no such a problem occurs.

### Comparative Example 16

A belt obtained in the same manner as in Comparative Example 12 was set in the electrophotographic apparatus shown in FIG. 3, as its intermediate transfer belt. Evaluation was made in the same manner as in Example 21. In this Comparative Example, the value of A/B was as small as 3, and hence it was unable to achieve both the prevention of polka dot pattern and the attracting force. The results of evaluation are shown in Table 10.

The difference between this Comparative Example and Comparative Example 7 resides in the presence or absence of the polyhydric alcohol type nonionic surface-active agent. However, as can be seen from comparison of the evaluation results shown in Table 8 and Table 10, the evaluation results in Comparative Example 7 and this Comparative Example are at the same level. That is, when the value of A/B was not within the range of the present invention, useful effects were not seen even with the addition of the polyhydric alcohol type nonionic surface-active agent.

### Comparative Example 17

A belt obtained in the same manner as in Comparative Example 13 was set in the electrophotographic apparatus shown in FIG. 3, as its intermediate transfer belt. Evaluation was made in the same manner as in Example 21. In this Comparative Example, the value of A/B was as large as 55, and hence it was unable to achieve both the prevention of polka dot pattern and the attracting force. The dendritic pattern was also seen in the patch images after 10,000-sheet running, resulting in a poor stability of image density as compared with the initial stage. The results of evaluation are shown in Table 10.

The difference between this Comparative Example and Comparative Example 8 resides in the presence or absence of the polyhydric alcohol type nonionic surface-active agent. where, as can be seen from the comparison of the evaluation results shown in Table 8 and Table 10, the evaluation results in Comparative Example 8 and this Comparative Example are at the same level. That is, when the value of A/B was not within the range of the present invention, useful effects were not seen even with the addition of the polyhydric alcohol type nonionic surface-active agent.

### Comparative Example 18

A belt obtained in the same manner as in Comparative Example 12 was set in the electrophotographic apparatus shown in FIG. 2, as its intermediate transfer belt. Evaluation was made in the same manner as in Example 22. In this Comparative Example, the value of A/B was as small as 3, and hence it was unable to achieve both the prevention of polka dot pattern and the attracting force. The results of evaluation are shown in Table 10.

The difference between this Comparative Example and Comparative Example 9 resides in the presence or absence of the polyhydric alcohol type nonionic surface-active agent. However, as can be seen from comparison of the evaluation results shown in Table 8 and Table 10, the evaluation results in Comparative Example 9 and this Comparative Example are at the same level. That is, when the value of A/B was not within the range of the present invention, useful effects were not seen even with the addition of the polyhydric alcohol type nonionic surface-active agent.

### Comparative Example 19

A belt obtained in the same manner as in Comparative Example 13 was set in the electrophotographic apparatus shown in FIG. 2, as its intermediate transfer belt. Evaluation was made in the same manner as in Example 22. In this Comparative Example, the value of A/B was as large as 55, and hence it was unable to achieve both the prevention of polka dot pattern and the attracting force. The dendritic pattern was also seen in the patch images after 10,000-sheet running, resulting in a poor stability of image density as compared with the one at the initial stage. The results of evaluation are shown in Table 10.

The difference between this Comparative Example and Comparative Example 10 resides in the presence or absence of the polyhydric alcohol type nonionic surface-active agent where, as can be seen from comparison of the evaluation results shown in Table 8 and Table 10, the evaluation results in Comparative Example 10 and this Comparative Example are at the same level. That is, when the value of A/B was not within the range of the present invention, useful effects were not seen even with the addition of the polyhydric alcohol type nonionic surface-active agent.

TABLE 1

| | | | | | | | | | | Endless |
|---|---|---|---|---|---|---|---|---|---|---|
| | | | PEEA, POE | | | | Other | | | belt |
| | PVDF | | and/or PEA | | Carbon | | component(s) | | Carbon content/ | volume |
| | | Amount | | Amount | | Amount | | Amount | PEEA, POE and/or | resistivity |
| Example: | Type | (mass %) | Type | (mass %) | Type | (mass %) | Type | (mass %) | PEA total content | (Ωcm) |
| 1 | A | 89.5 | B | 0.5 | E | 5.0 | K | 5 | 10 | 2 × 10¹³ |
| 2 | A | 94.9 | B | 0.1 | E | 5.0 | — | — | 50 | 2 × 10¹³ |
| 3 | A | 93.7 | B | 0.9 | E | 5.4 | — | — | 6 | 2 × 10¹³ |
| 4 | A | 91 | B | 1.8 | E | 7.2 | — | — | 4 | 5 × 10¹⁰ |
| 5 | A | 84.8 | B | 0.9 | E | 6.3 | K | 8 | 7 | 1 × 10¹³ |
| 6 | A | 83.5 | B | 1.5 | G | 15 | — | — | 10 | 1 × 10¹² |
| 7 | A | 92.45 | C | 0.5 | E | 6 | I | 0.05 | 12 | 3 × 10¹² |
| | | | | | | | K | 1 | | |
| 8 | A | 93.65 | D | 0.3 | E | 6 | J | 0.05 | 20 | 8 × 10¹¹ |
| 9 | A | 86.1 | B | 0.3 | E | 2 | K | 10 | 5.5 | 5 × 10¹⁴ |
| | | | C | 0.3 | F | 1.3 | | | | |
| 10 | A | 50 | B | 0.5 | E | 1 | I | 1.0 | 4 | 2 × 10¹³ |
| | | | | | F | 1 | K | 46.5 | | |
| 11 | A | 74 | B | 0.7 | E | 7 | I | 0.3 | 10 | 1 × 10¹¹ |
| | | | | | | | K | 18 | | |
| 12 | A | 89 | B | 1 | H | 10 | — | — | 10 | 2 × 10¹³ |

A: PVD homopolymer (KYNAR 720, available from Arkema Co.)
B: Polyether ester amide (PEEA) resin (PELESTAT NC63, available from Sanyo Chemical Industries, Ltd.)
C: Polyolefin ether (POE) resin (PELESTAT 300, available from Sanyo Chemical Industries, Ltd.)
D: Polyether amide (PEA) resin (PEBAX 2533, available from Arkema Co.)
E: Carbon black (DENKA BLACK powdery product; primary particle diameter: 35 nm, available from Denki Kagaku Kogyo Kabushiki Kaisha)
F: Carbon black (KETJEN BLACK EC600JD; primary particle diameter: 34 nm, available from Lion Akzo Co., Ltd.)
G: Carbon black (SEAST SP SRF-LS; primary particle diameter: 95 nm, available from Tokai Carbon Co., Ltd.)
H: Grafted carbon black (see Production Example 1)
I: Potassium perfluorobutanesulfonate (KFBS; available from Mitubishi Materials Corporation)
J: Sodium perfluorooctanesulfonate (EFTOP EF-103, available from Jemco Inc.)
K: Zinc oxide (zinc oxide first class; average particle diameter: 0.6 μm; available from Sakai Chemical Industry Co., Ltd.)
K is zinc oxide not subjected to conductive treatment.

TABLE 2

| | | | | | | | | | | Endless |
|---|---|---|---|---|---|---|---|---|---|---|
| | | | PEEA, POE | | | | Other | | | belt |
| | PVDF | | and/or PEA | | Carbon | | component(s) | | Carbon content/ | volume |
| | | Amount | | Amount | | Amount | | Amount | PEEA, POE and/or | resistivity |
| | Type | (mass %) | Type | (mass %) | Type | (mass %) | Type | (mass %) | PEA total content | (Ωcm) |
| Example: | | | | | | | | | | |
| 13 | A | 97.9 | B | 0.1 | F | 2 | — | — | 20 | 1 × 10¹³ |
| 14 | A | 84.7 | B | 0.3 | G | 15 | — | — | 50 | 5 × 10¹² |
| 15 | A | 83.2 | B | 1.8 | G | 15 | — | — | 8.33 | 5 × 10¹¹ |
| 16 | A | 97 | B | 0.5 | F | 2 | J | 0.5 | 4 | 5 × 10¹² |
| 17 | A | 84.8 | B | 0.9 | E | 6.3 | K | 8 | 7 | 1 × 10¹³ |
| 18 | A | 81.9 | B | 3 | G | 15 | I | 0.1 | 5 | 1 × 10¹¹ |
| 19 | A | 83.1 | B | 0.9 | G | 15 | K | 1 | 16.67 | 1 × 10¹² |
| 20 | A | 95.5 | C | 0.9 | E | 3.6 | — | — | 4 | 1 × 10¹³ |
| Comparative | | | | | | | | | | |
| Example: | | | | | | | | | | |
| 1 | A | 94.9 | D | 5 | — | — | I | 0.1 | 0 | 5 × 10¹¹ |
| 2 | A | 95 | — | — | E | 5 | — | — | — | 2 × 10¹³ |
| 3 | A | 92 | B | 2 | E | 6 | — | — | 3 | 2 × 10¹³ |
| 4 | A | 94.96 | B | 0.09 | E | 4.95 | — | — | 55 | 2 × 10¹³ |
| 5 | A | 90.3 | B | 4 | E | 5.7 | — | — | 1.43 | 9 × 10⁹ |
| 6 | A | 90.3 | B | 4 | H | 5.7 | — | — | 1.43 | 9 × 10⁹ |

A: PVD homopolymer (KYNAR 720, available from Arkema Co.)
B: Polyether ester amide (PEEA) resin (PELESTAT NC63, available from Sanyo Chemical Industries, Ltd.)
C: Polyolefin ether (POE) resin (PELESTAT 300, available from Sanyo Chemical Industries, Ltd.)
D: Polyether amide (PEA) resin (PEBAX 2533, available from Arkema Co.)
E: Carbon black (DENKA BLACK powdery product; primary particle diameter: 35 nm, available from Denki Kagaku Kogyo Kabushiki Kaisha)
F: Carbon black (KETJEN BLACK EC600JD; primary particle diameter: 34 nm, available from Lion Akzo Co., Ltd.)
G: Carbon black (SEAST SP SRF-LS; primary particle diameter: 95 nm, available from Tokai Carbon Co., Ltd.)
H: Grafted carbon black (see Production Example 1)
I: Potassium perfluorobutanesulfonate (KFBS; available from Mitubishi Materials Corporation)
J: Sodium perfluorooctanesulfonate (EFTOP EF-103, available from Jemco Inc.)
K: Zinc oxide (zinc oxide first class; average particle diameter: 0.6 μm; available from Sakai Chemical Industry Co., Ltd.)
K is zinc oxide not subjected to conductive treatment.

TABLE 3

| | | | | | | | | | | Endless |
|---|---|---|---|---|---|---|---|---|---|---|
| | | | PEEA, POE | | | | Other | | | belt |
| | PVDF | | and/or PEA | | Carbon | | component(s) | | Carbon content/ | volume |
| | | Amount | | Amount | | Amount | | Amount | PEEA, POE and/or | resistivity |
| | Type | (mass %) | Type | (mass %) | Type | (mass %) | Type | (mass %) | PEA total content | (Ωcm) |
| Example: | | | | | | | | | | |
| 21 | A | 89.5 | B | 0.5 | E | 5 | K | 5 | 10 | 2 × 10¹³ |
| 22 | A | 89.5 | B | 0.5 | E | 5 | K | 5 | 10 | 2 × 10¹³ |
| Comparative | | | | | | | | | | |
| Example: | | | | | | | | | | |
| 7 | A | 92 | B | 2 | E | 6 | — | — | 3 | 2 × 10¹³ |
| 8 | A | 94.96 | B | 0.09 | E | 4.95 | — | — | 55 | 2 × 10¹³ |
| 9 | A | 92 | B | 2 | E | 6 | — | — | 3 | 2 × 10¹³ |
| 10 | A | 94.96 | B | 0.09 | E | 4.95 | — | — | 55 | 2 × 10¹³ |

A: PVD homopolymer (KYNAR 720, available from Arkema Co.)
B: Polyether ester amide (PEEA) resin (PELESTAT NC63, available from Sanyo Chemical Industries, Ltd.)
C: Polyolefin ether (POE) resin (PELESTAT 300, available from Sanyo Chemical Industries, Ltd.)
D: Polyether amide (PEA) resin (PEBAX 2533, available from Arkema Co.)
E: Carbon black (DENKA BLACK powdery product; primary particle diameter: 35 nm, available from Denki Kagaku Kogyo Kabushiki Kaisha)
F: Carbon black (KETJEN BLACK EC600JD; primary particle diameter: 34 nm, available from Lion Akzo Co., Ltd.)
G: Carbon black (SEAST SP SRF-LS; primary particle diameter: 95 nm, available from Tokai Carbon Co., Ltd.)
H: Grafted carbon black (see Production Example 1)
I: Potassium perfluorobutanesulfonate (KFBS; available from Mitubishi Materials Corporation)
J: Sodium perfluorooctanesulfonate (EFTOP EF-103, available from Jemco Inc.)
K: Zinc oxide (zinc oxide, first class; average particle diameter: 0.6 μm; available from Sakai Chemical Industry Co., Ltd.)
K is zinc oxide not subjected to conductive treatment.

TABLE 4

| | | | | | | | Polyhydric | | | | Carbon | Polyhydric | |
|---|---|---|---|---|---|---|---|---|---|---|---|---|---|
| | | | | | | | alcohol | | | | content/ | alcohol | |
| | | | | | | | type | | | | PEEA, | type | |
| | | | PEEA, POE | | | | nonionic | | | | POE | nonionic | Endless |
| | | | and/or PEA | | Carbon | | surfactant | | Other | | and/or | surfactant | belt |
| | PVDF | | (B) | | (A) | | (C) | | component(s) | | PEA | content/ | volume |
| Exam- | | Amount | | Amount | | Amount | | Amount | | Amount | total | carbon | resistivity |
| ple: | Type | (mass %) | Type | (mass %) | Type | (mass %) | Type | (mass %) | Type | (mass %) | content | content | (Ωcm) |
| 23 | A | 75.928 | B | 1.8 | E | 6.48 | N | 0.072 | M | 5 | 4 | 0.01 | 5 × 10¹⁰ |
| | | | | | L | 0.72 | | | K | 10 | | | |
| 24 | A | 75.24 | C | 1.8 | G | 1.08 | N | 2.16 | M | 5 | 6 | 0.2 | 8 × 10¹¹ |
| | | | | | L | 9.72 | | | K | 5 | | | |
| 25 | A | 97.88 | D | 0.1 | F | 1.8 | N | 0.02 | — | — | 20 | 0.01 | 8 × 10¹³ |
| | | | | | L | 0.2 | | | | | | | |
| 26 | A | 84.2 | B | 0.9 | E | 4.5 | P | 0.9 | M | 1 | 10 | 0.1 | 5 × 10¹² |
| | | | | | L | 4.5 | | | K | 4 | | | |
| 27 | A | 76.4 | C | 0.3 | G | 3 | P | 0.3 | M | 2 | 50 | 0.02 | 1 × 10¹¹ |
| | | | | | L | 12 | | | K | 6 | | | |
| 28 | A | 50 | B | 0.3 | F | 1.8 | N | 0.6 | M | 40 | 4 | 0.3 | 4 × 10¹² |
| | | | C | 0.2 | L | 0.2 | | | K | 6.9 | | | |
| 29 | A | 73.95 | B | 0.9 | G | 3 | N | 0.15 | M | 3 | 16.67 | 0.01 | 1 × 10¹¹ |
| | | | | | L | 12 | | | K | 7 | | | |
| 30 | A | 86.65 | B | 0.1 | F | 1 | N | 0.25 | M | 7 | 50 | 0.05 | 2 × 10¹³ |
| | | | | | L | 4 | | | K | 1 | | | |
| 31 | A | 94.1 | C | 0.5 | G | 1.8 | N | 0.4 | M | 1 | 4 | 0.2 | 8 × 10¹³ |
| | | | | | L | 0.2 | | | K | 2 | | | |
| 32 | A | 87.14 | D | 0.9 | F | 1.8 | N | 0.36 | M | 1 | 4 | 0.1 | 4 × 10¹³ |
| | | | | | L | 1.8 | | | K | 7 | | | |
| 33 | A | 77.95 | B | 1.8 | G | 3 | N | 2.25 | M | 2 | 8.33 | 0.15 | 1 × 10¹¹ |
| | | | | | L | 12 | | | K | 1 | | | |
| 34 | A | 89 | B | 0.5 | E | 5 | N | 0.5 | K | 5 | 10 | 0.1 | 2 × 10¹³ |
| 35 | A | 83 | B | 1 | H | 10 | N | 1 | K | 5 | 10 | 0.1 | 2 × 10¹³ |
| 36 | A | 76.75 | C | 2.5 | G | 3 | N | 0.75 | M | 3 | 6 | 0.05 | 5 × 10¹⁰ |
| | | | | | L | 12 | | | K | 2 | | | |

A: PVD homopolymer (KYNAR 720, available from Arkema Co.)
B: Polyether ester amide (PEEA) resin (PELESTAT NC63, available from Sanyo Chemical Industries, Ltd.)
C: Polyolefin ether (POE) resin (PELESTAT 300, available from Sanyo Chemical Industries, Ltd.)
D: Polyether amide (PEA) resin (PEBAX 2533, available from Arkema Co.)
E: Carbon black (DENKA BLACK powdery product; primary particle diameter: 35 nm, available from Denki Kagaku Kogyo Kabushiki Kaisha)
F: Carbon black (KETJEN BLACK EC600JD; primary particle diameter: 34 nm, available from Lion Akzo Co., Ltd.)
G: Carbon black (SEAST SP SRF-LS; primary particle diameter: 95 nm, available from Tokai Carbon Co., Ltd.)
H: Grafted carbon black (see Production Example 1)
I: Potassium perfluorobutanesulfonate (KFBS; available from Mitubishi Materials Corporation)
J: Sodium perfluorooctanesulfonate (EFTOP EF-103, available from Jemco Inc.)
K: Zinc oxide (zinc oxide first class; average particle, diameter: 0.6 μm; available from Sakai Chemical Industry Co., Ltd.)
K is zinc oxide not subjected to conductive treatment.
L: Graphite powder (UF-G10; average particle diameter: 4 μm; available from Showa Denko K.K.
M: Zinc oxide surface-treated with dimethylsilicone oil (PIGMOLITE Fine Zinc White B; average particle diameter: 0.2 μm; available from Daito Kasei Kogyo Co., Ltd.)
N: Condensed ricinoleic acid polyglycerol ester (TYRABAZOLE H-818; available from Taiyo Kagaku Co., Ltd.)
P: Polyglycerol stearic ester (TYRABAZOLE P-4; available from Taiyo Kagaku Co., Ltd.)

TABLE 5

| | | | | | | | Polyhydric | | | | Carbon | Polyhydric | |
|---|---|---|---|---|---|---|---|---|---|---|---|---|---|
| | | | | | | | alcohol | | | | content/ | alcohol | |
| | | | | | | | type | | | | PEEA, | type | |
| | | | PEEA, POE | | | | nonionic | | | | POE | nonionic | Endless |
| Com- | | | and/or PEA | | Carbon | | surfactant | | Other | | and/or | surfactant | belt |
| parative | PVDF | | (B) | | (A) | | (C) | | component(s) | | PEA | content/ | volume |
| Exam- | | Amount | | Amount | | Amount | | Amount | | Amount | total | carbon | resistivity |
| ple: | Type | (mass %) | Type | (mass %) | Type | (mass %) | Type | (mass %) | Type | (mass %) | content | content | (Ωcm) |
| 11 | A | 94.5 | — | — | E | 5 | N | 0.5 | — | — | — | 0.1 | 2 × 10¹³ |
| 12 | A | 91.44 | B | 2 | E | 6 | N | 0.6 | — | — | 3 | 0.1 | 4 × 10¹³ |
| 13 | A | 94.465 | B | 0.09 | E | 4.95 | N | 0.495 | — | — | 55 | 0.1 | 1 × 10¹¹ |
| 14 | A | 89.73 | B | 4 | E | 5.7 | N | 0.57 | — | — | 1.43 | 0.1 | 9 × 10⁹ |
| 15 | A | 89.73 | B | 4 | H | 5.7 | N | 0.57 | — | — | 1.43 | 0.1 | 9 × 10⁹ |

A: PVD homopolymer (KYNAR 720, available from Arkema Co.)
B: Polyether ester amide (PEEA) resin (PELESTAT NC63, available from Sanyo Chemical Industries, Ltd.)
C: Polyolefin ether (POE) resin (PELESTAT 300, available from Sanyo Chemical Industries, Ltd.)
D: Polyether amide (PEA) resin (PEBAX 2533, available from Arkema Co.)
E: Carbon black (DENKA BLACK powdery product; primary particle diameter: 35 nm, available from Denki Kagaku Kogyo Kabushiki Kaisha)
F: Carbon black (KETJEN BLACK EC600JD; primary particle diameter: 34 nm, available from Lion Akzo Co., Ltd.)
G: Carbon black (SEAST SP SRF-LS; primary particle diameter: 95 nm, available from Tokai Carbon Co., Ltd.)
H: Grafted carbon black (see Production Example 1)
I: Potassium perfluorobutanesulfonate (KFBS; available from Mitubishi Materials Corporation)
J: Sodium perfluorooctanesulfonate (EFTOP EF-103, available from Jemco Inc.)
K: Zinc oxide (zinc oxide first class; average particle diameter: 0.6 μm; available from Sakai Chemical Industry Co., Ltd.)
K is zinc oxide not subjected to conductive treatment.
L: Graphite powder (UF-G10; average particle diameter: 4 μm; available from Showa Denko K.K.
M: Zinc oxide surface-treated with dimethylsilicone oil (PIGMOLITE Fine Zinc White B; average particle diameter: 0.2 μm; available from Daito Kasei Kogyo Co., Ltd.)
N: Condensed ricinoleic acid polyglycerol ester (TYRABAZOLE H-818; available from Taiyo Kagaku Co., Ltd.)
P: Polyglycerol stearic ester (TYRABAZOLE P-4; available from Taiyo Kagaku Co., Ltd.)

TABLE 6

| | | | | | | | Polyhydric | | | | Carbon | Polyhydric | |
|---|---|---|---|---|---|---|---|---|---|---|---|---|---|
| | | | | | | | alcohol | | | | content/ | alcohol | |
| | | | | | | | type | | | | PEEA, | type | |
| | | | PEEA, POE | | | | nonionic | | | | POE | nonionic | Endless |
| | | | and/or PEA | | Carbon | | surfactant | | Other | | and/or | surfactant | belt |
| | PVDF | | (B) | | (A) | | (C) | | component(s) | | PEA | content/ | volume |
| | | Amount | | Amount | | Amount | | Amount | | Amount | total | carbon | resistivity |
| | Type | (mass %) | Type | (mass %) | Type | (mass %) | Type | (mass %) | Type | (mass %) | content | content | (Ωcm) |
| Exam- | | | | | | | | | | | | | |
| ple: | | | | | | | | | | | | | |
| 37 | A | 84.2 | B | 0.9 | E | 4.5 | P | 0.9 | M | 1 | 10 | 0.1 | 5 × 10¹² |
| | | | | | L | 4.5 | | | K | 4 | | | |
| 38 | A | 84.2 | B | 0.9 | E | 4.5 | P | 0.9 | M | 1 | 10 | 0.1 | 5 × 10¹² |
| | | | | | L | 4.5 | | | K | 4 | | | |
| Com- | | | | | | | | | | | | | |
| parative | | | | | | | | | | | | | |
| Exam- | | | | | | | | | | | | | |
| ple: | | | | | | | | | | | | | |
| 16 | A | 94.5 | — | — | E | 5 | N | 0.5 | — | — | — | 0.1 | 2 × 10¹³ |
| 17 | A | 91.4 | B | 2 | E | 6 | N | 0.6 | — | — | 3 | 0.1 | 4 × 10¹³ |
| 18 | A | 94.465 | B | 0.09 | E | 4.95 | N | 0.495 | — | — | 55 | 0.1 | 1 × 10¹¹ |
| 19 | A | 89.73 | B | 4 | E | 5.7 | N | 0.57 | — | — | 1.43 | 0.1 | 9 × 10⁹ |

A: PVD homopolymer (KYNAR 720, available from Arkema Co.)
B: Polyether ester amide (PEEA) resin (PELESTAT NC63, available from Sanyo Chemical Industries, Ltd.)
C: Polyolefin ether (POE) resin (PELESTAT 300, available from Sanyo Chemical Industries, Ltd.)
D: Polyether amide (PEA) resin (PEBAX 2533, available from Arkema Co.)
E: Carbon black (DENKA BLACK powdery product; primary particle diameter: 35 nm, available from Denki Kagaku Kogyo, Kabushiki Kaisha)
F: Carbon black (KETJEN BLACK EC600JD; primary particle diameter: 34 nm, available from Lion Akzo Co., Ltd.)
G: Carbon black (SEAST SP SRF-LS; primary particle diameter: 95 nm, available from Tokai Carbon Co., Ltd.)
H: Grafted carbon black (see Production Example 1)
I: Potassium perfluorobutanesulfonate (KFBS; available from Mitubishi Materials Corporation)
J: Sodium perfluorooctanesulfonate (EFTOP EF-103, available from Jemco Inc.)
K: Zinc oxide (zinc oxide first class; average particle diameter: 0.6 μm; available from Sakai Chemical Industry Co., Ltd.)
K is zinc oxide not subjected to conductive treatment.
L: Graphite powder (UF-G10; average particle diameter: 4 μm; available from Showa Denko K.K.
M: Zinc oxide surface-treated with dimethylsilicone oil (PIGMOLITE Fine Zinc White B; average particle diameter: 0.2 μm; available from Daito Kasei kogyo Co., Ltd.)
N: Condensed ricinoleic acid polyglycerol ester (TYRABAZOLE H-818; available from Taiyo Kagaku Co., Ltd.)
P: Polyglycerol stearic ester (TYRABAZOLE P-4; available from Taiyo Kagaku Co., Ltd.)

TABLE 7

| | | | | Evaluation made | | |
|---|---|---|---|---|---|---|
| | | Evaluation made using CLC | | using CLC thick-gage | | |
| | | sheet (basis wt.: 81.4 g/m²) | | sheet NS700 (basis wt.: 157 g/m²) | | Belt |
| | Polka dot | Color | Rear-end horizontal | Color | | thickness |
| | pattern | aberration | lines | aberration | Rear-end horizontal lines | (μm) |
| Example: | | | | | | |
| 1 | A | A | A | B | B | 100 |
| 2 | C | A | A | B | B | 100 |
| 3 | A | A | A | B | B | 60 |
| 4 | B | C | C | C | C | 100 |
| 5 | A | A | A | B | B | 130 |
| 6 | A | B | B | B | B | 100 |
| 7 | A | A | A | B | B | 100 |
| 8 | A | A | A | B | B | 100 |
| 9 | B | A | A | B | B | 100 |
| 10 | C | A | A | B | B | 100 |
| 11 | A | A | A | B | B | 100 |
| 12 | C | C | C | C | C | 100 |
| 13 | A | A | A | B | B | 100 |
| 14 | A | A | A | B | B | 100 |
| 15 | A | B | B | B | C | 100 |
| 16 | A | A | A | B | B | 100 |
| 17 | C | A | A | B | B | 150 |
| 18 | A | C | C | C | C | 100 |
| 19 | A | A | A | B | B | 100 |
| 20 | A | A | A | B | B | 100 |
| Comparative | | | | | | |
| Example: | | | | | | |
| 1 | C | D | D | D | D | 100 |
| 2 | D | C | C | C | C | 100 |
| 3 | C | D | D | D | D | 100 |
| 4 | D | C | C | C | C | 100 |
| 5 | C | D | D | D | D | 100 |
| 6 | C | D | D | D | D | 100 |

TABLE 8

| | | Re-transfer | | |
|---|---|---|---|---|
| | | Evaluation | Evaluation | Belt thickness |
| | Polka dot pattern | mode 1 | mode 2 | (μm) |
| Example: | | | | |
| 21 | A | A | B | 100 |
| 22 | A | A | B | 100 |
| Comparative | | | | |
| Example: | | | | |
| 7 | B | C | D | 100 |
| 8 | C | B | C | 100 |
| 9 | B | C | D | 100 |
| 10 | C | B | C | 100 |

TABLE 9

| | | | | Evaluation made | | |
|---|---|---|---|---|---|---|
| | | Evaluation made using CLC | | using CLC thick-gage | | |
| | | sheet (basis wt.: 81.4 g/m²) | | sheet NS700 (basis wt.: 157 g/m²) | | Belt |
| | Polka dot | Color | Rear-end horizontal | Color | | thickness |
| | pattern | aberration | lines | aberration | Rear-end horizontal lines | (μm) |
| Example: | | | | | | |
| 23 | A | A | A | A | B | 100 |
| 24 | A | A | A | A | B | 130 |
| 25 | A | A | A | A | A | 100 |
| 26 | A | A | A | A | A | 100 |
| 27 | A | A | A | A | A | 100 |
| 28 | A | A | A | A | A | 100 |
| 29 | A | A | A | A | A | 100 |
| 30 | A | A | A | A | A | 100 |
| 31 | A | A | A | A | A | 100 |
| 32 | A | A | A | A | A | 100 |
| 33 | A | A | A | A | B | 100 |
| 34 | A | A | A | A | B | 60 |
| 35 | C | C | C | C | C | 100 |
| 36 | A | A | A | B | B | 100 |
| Comparative | | | | | | |
| Example: | | | | | | |
| 11 | D | C | C | C | C | 100 |
| 12 | C | D | D | D | D | 100 |
| 13 | D | C | C | C | C | 100 |
| 14 | C | D | D | D | D | 100 |
| 15 | C | D | D | D | D | 100 |

TABLE 10

| | | Re-transfer | | |
|---|---|---|---|---|
| | | Evaluation | Evaluation | Belt thickness |
| | Polka dot pattern | mode 1 | mode 2 | (μm) |
| Example: | | | | |
| 37 | A | A | A | 100 |
| 38 | A | A | A | 100 |
| Comparative | | | | |
| Example: | | | | |
| 16 | B | C | D | 100 |
| 17 | C | B | C | 100 |
| 18 | B | C | D | 100 |
| 19 | C | B | C | 100 |

As having been described above, the present invention can provide an electrophotographic endless belt having high attracting force and the stability of image density during repeated image reproduction when used as a transfer material transport belt. The present invention also provides an electrophotographic endless belt which has the stability of image density during repeated image reproduction and is not causative of re-transfer when used as an intermediate transfer belt, and an electrophotographic apparatus having such an electrophotographic endless belt.

This application claims priority from Japanese Patent Application No. 2005-109883 filed Apr. 6, 2005, which is hereby incorporated by reference herein.

What is claimed is:

1. An electrophotographic endless belt which has a layer comprising a resin composition containing:
(i) at least one resin selected from the group consisting of a polyether ester amide, a polyolefin ether and a polyether amide;
(ii) polyvinylidene fluoride; and
(iii) carbon;
in said resin composition, a mass (A) of the component (iii) and a mass (B) of the component (i) being in a ratio A/B of from 4 or more to 50 or less.

2. The electrophotographic photosensitive member according to claim 1, wherein said resin composition contains the component (i) in an amount of from 0.1% by mass or more to 1.8% by mass or less, contains the component (ii) in an amount of from 50.0% by mass or more to 97.9% by mass or less, and contains the component (iii) in an amount, of from 2.0% by mass or more to 15.0% by mass ort less.

3. The electrophotographic photosensitive member according to claim 2, wherein said resin composition contains the component (i) in an amount of from 0.1% by mass or more to 0.9.

4. The electrophotographic photosensitive member according to claim 1, wherein said resin composition further contains (iv) a polyhydric alcohol, type nonionic surface-active agent.

5. The electrophotographic photosensitive member according to claim 4, wherein, in said resin composition, a mass (C) of the component from 0.01 or more to 0.30 or less.

6. The electrophotographic photosensitive member according to claim 5, wherein the component (iv) polyhydric alcohol type nonionic surface-active agent is a glycerol fatty ester.

7. The electrophotographic photosensitive member according to claim 6, wherein said glycerol fatty ester is at least one of a condensed ricinoleic acid polyglycerol ester and a polyglycerol stearic ester.

8. An electrophotographic apparatus having an electrophotographic endless belt;
said electrophotographic endless belt being an electrophotographic endless belt which has a layer comprising a resin composition containing:
(i) at least one resin selected from the group consisting of a polyether ester amide, a polyolefin ether and a polyether amide;
(ii) polyvinylidene fluoride; and
(iii) carbon;
in said resin composition, a mass (A) of the component (iii) and a mass (B) of the component (i) being in a ratio A/B of from 4 or more to 50 or less.

9. A process for producing an electrophotographic endless belt which has a layer comprising a resin composition containing:
(i) at least one resin selected from the group consisting of a polyether ester amide, a polyolefin ether and a polyether amide;
(ii) polyvinylidene fluoride; and
(iii) carbon;
in said resin composition, a mass (A) of the component (iii) and a mass (B) of the component (i) being in a ratio A/B of from 4 or more to 50 or less;
the process comprising the steps of:
previously melt-kneading polyvinylidene fluoride, carbon and a polyhydric alcohol type nonionic surface-active agent, followed by pulverization to produce a pulverized product;
melt-kneading at least one resin selected from the group consisting of a polyether ester amide, a polyolefin ether and a polyether amide, the pulverized product and polyvinylidene fluoride to prepare a resin composition; and
melt-extruding the resin composition to produce a tubular film.
